(19) United States
(12) Patent Application Publication
(10) Pub. No.: US 2006/0111848 A1
(43) Pub. Date: May 25, 2006

(54) Identification and use of cofactor independent phosphoglycerate mutase as a drug target for pathogenic organisms and treatment of the same

(75) Inventors: Clotilde Carlow, South Hamilton, MA (US); Yinhua Zhang, North Reading, MA (US); Jeremy Foster, Beverly, MA (US); Sanjay Kumar, Ipswich, MA (US)

Correspondence Address: HARRIET M. STRIMPEL; NEW ENGLAND BIOLABS, INC., 240 COUNTY ROAD, IPSWICH, MA, 01938-2723, US

(73) Assignee: New England Biolabs, Inc., Ipswich, MA (US)

(21) Appl. No.: 11/316,521

(22) Filed: Dec. 22, 2005

Related U.S. Application Data
(63) Continuation-in-part of application No. PCT/US04/18200, filed on Jun. 4, 2004.
(60) Provisional application No. 60/483,566, filed on Jun. 27, 2003.

(51) Int. Cl. G06F 19/00

(52) U.S. Cl. 702/19; 702/20

(57) ABSTRACT

Present embodiments of the invention describe computational methods for performing a systematic, genome-wide search for novel drug targets in pathogenic organisms for example, the human filarial parasites. Cofactor independent phosphoglycerate mutase (iPGM) was identified by this search as a candidate target for identifying therapeutic agents for use in treating animal or plant subjects infected with parasitic nematodes, microbial pathogens including microsporidia, fungi etc. A consensus amino acid or nucleotide sequence that characterizes iPGM is further provided.

### CROSS REFERENCE

This application is a continuation-in-part application under 35 U.S.C. 111(a) of International Patent Application No. PCT/US2004/018200 filed Jun. 4, 2004, which claims priority from U.S. Provisional Application No. 60/483,566 filed Jun. 27, 2003, both of which are incorporated herein by reference.

### BACKGROUND

For many infectious diseases, which exist today, there are no treatments available or, if treatments exist, they are generally inadequate. In particular, different life cycle stages in pathogenic organisms that have multiple developmental forms may not respond to a single treatment throughout. Current treatments may also be ineffective when the pathogen has lost its susceptibility to the drug as a result of drug resistance. These major problems are common to infectious diseases caused by a wide range of pathogens of vertebrates and plants including bacteria, fungi, yeast, parasitic protozoa and worms. There is therefore an urgency to develop new therapeutic drugs for treating infectious diseases. To this end, identification of novel drug targets in pathogens is an important step.

Traditionally, drug targets for infectious disease are selected following in-depth studies on the biology of the invading organism to determine which factors are essential for survival and infectivity and whether these targets are absent in vertebrate or plant hosts. Preferably, candidate drug targets should have an essential role in: maintaining viability; reproduction, or infecting the host. In many cases, identification of novel drug targets has been hampered by the complexity of the host-pathogen interaction. Moreover, these studies have been hampered by difficulties in identifying potential drug targets and then obtaining sufficient quantities for analysis. This is particularly relevant to parasites, which are notoriously difficult to maintain in the laboratory due to complex life cycles and host specificity. In addition, many pathogens are not genetically tractable, so that it may be extremely difficult to determine if a particular molecule within the pathogen is a suitable drug target in the absence of a known inhibitor. Consequently, some form of validation of a potential drug target is desirable prior to an involved search for novel inhibitors that may serve as drug leads.

Filarial nematodes are parasitic roundworms responsible for a number of infectious diseases in humans and animals. They have a worldwide distribution and a life cycle involving a period of development in both insect vector and vertebrate hosts. Currently available drugs are ineffective against the adult worms, which are often largely responsible for the pathology associated with these infections.

Among pathogenic organisms, filarial nematodes appear unique in their possession of an intracellular symbiotic bacterium. This adds to the complexity of analyzing their genome and proteome, yet perhaps surprisingly provides additional drug target opportunities. These rickettsia-like bacteria belong to the genus Wolbachia and are related to the Wolbachia endosymbionts of arthropods, which are known to regulate a number of processes in their insect host including reproduction, gender and survival. In filarial parasites, Wolbachia are essential for worm survival as illustrated when tetracycline is administered to infected vertebrates. Tetracycline reduces the bacterial load within the worms and causes sterilization of adult females. Therefore, the Wolbachia organism itself represents a drug target for filarial infection. Similar challenges described above are encountered in indentifying which Wolbachia molecules are essential for the survival of bacteria within its parasite host.

To aid in the search for therapeutic targets, a plethora of new sources of genetic, gene expression and protein data are available for particular pathogens, model organisms and mammals. There is a need for methods, which can provide effective analysis of these databases to obtain drug target information.

### SUMMARY OF EMBODIMENTS

In an embodiment of the invention, a computational method is provided for identifying one or more proteins in a pathogen that may be suitable for identifying a therapeutic agent. The method includes determining computationally from a genome wide RNA gene silencing database whether loss or alteration of one or more proteins results in a phenotypic change detrimental to a pathogen. The computational method further determines from a gene sequence database by sequence matching algorithms whether the one or more proteins occur exclusively in the pathogen and not in its host. Those proteins that both cause a phenotypic change when inhibited and are unique to the pathogen and not to the host are then arranged in a ranking order. From the ranking order according to their properties, proteins are recognized that are suitable candidates for targets to identify therapeutic agents.

The computational method can be applied to any pathogen including, for example, a parasitic nematode, a fungus, a microbial pathogen and a protozoan pathogen.

Examples of criteria for creating the ranking order include: (i) the occurrence of the protein in pathogens, (ii) relative homology among the amino acid sequences or DNA sequences of the protein isolated from different sources, (iii) physical properties of the protein for identifying therapeutic modulators, and (iv) an assay for measuring the functional activity of the protein.

In an embodiment of the invention, polynucleotides are described that contain a nucleotide sequence capable of hybridizing under stringent conditions to SEQ ID NO:1, wherein the polynucleotide encodes a protein having independent phosphoglycerate mutase (iPGM) activity. An example of this embodiment includes polynucleotides that have a nucleotide sequence selected from SEQ ID NOS: 2, 3, 4 and 5. In an additional embodiment, polynucleotides are defined that contain a sequence that has at least 50%, more particularly at least 60%, identity to SEQ ID. NO: 1 and encode iPGMs expressed in a pathogenic organism such as a nematode.

In an embodiment of the invention, a recombinant iPGM from a pathogenic organism is described that contains at least 50% amino acid identity with SEQ ID No. 6, more particularly for a nematode, at least 70% sequence identity with SEQ ID. No 6. Examples of recombinant nematode iPGMs include those having amino acid sequences selected from SEQ ID NOS: 7, 8, 9 and 10.

In another embodiment of the invention, a method for identifying an inhibitor of viability of a pathogen is described in which the pathogen is characterized by the presence of iPGM. The method includes (a) selecting one or more candidate inhibitor molecules for screening for inhibitory activity of iPGM; (b) performing a functional assay to determine which if any of the candidate molecules are capable of inhibitory activity; and (c) identifying from step (b) which candidate molecules have iPGM inhibitory activity capable of inhibiting viability of the pathogen.

Examples of pathogens that express iPGM include:

Microbial Pathogens: Mycoplasma gallisepticum, M. genitalium, M. mycoides, M. penetrans, M. pneumoniae, M. pulmonis, Onion yellows phytoplasma, Ureaplasma urealyticum, Clostridium peffingens, Agrobacterium tumefaciens, Wolbachia endosymbiont of filarial nematodes and arthropods, Campylobacter jejuni, Helicobacter hepaticus, H. pylori, Coxiella burnetii, Pseudomonas aeruginosa, P. syringae, Vibrio cholerae, V. parahaemolyticus, V. vulnificus, Leptospira interrogans, Encephalitozoon cuniculi

Fungi: Aspergillus fumigatus, Cryptococcus neoformans

Protozoa: Giardia lamblia, Leishmania mexicana, Trypanosoma brucei, T. cruzi, Entamoeba histolytica

Nematodes: Trichinella spiralis, Trichuris muris, Brugia malayi, Onchocerca volvulus, Litomosoides sigmodontis, Strongyloides stercoralis, Globodera rostochiensis, Meloidogyne incognita, Heterodera glycines, Haemonchus contortus, Ostertagia ostertagi, Necator americanus, Dirofilaria immitis, Wuchereria bancrofti, Onchocerca gibsoni, Loa loa, Toxococara canis, T. cati, Toxascaris leonina, Ancylostoma duodenale, A. braziliense, A. caninum, Ascaris lumbricoides, A. suum, Enterobius vermicularis, Trichuris trichiura, Parascaris equorum, Dictyocaulus viviparus, Uncinaria stenocephala, Ostertagia circumcincta, Cooperia oncophora, Trichostrongylus colubriformis, Nematodirus battus, Oesophagostomum radiatum, O. dentatum, Strongylus vulgaris, S. equinus. Dirofilaria immitis.

Essential bacterial symbionts of nematodes: Wolbacchia brugia and Wolbacchia dirofilaria immits.

Arthropods: Psoroptes ovis, Sarcoptes scabei, Amblyomma variegatum

Examples of functional assays include biochemical assays that measure the interconversion of 3-phosphoglycerate and 2-phosphoglycerate (2-PG or 3-PG) and biological assays, which measure the viability of the pathogen after treatment with the candidate inhibitor.

In particular, viability can be measured in nematodes by assaying inhibition of egg maturation, sterility, larval or adult lethality, or growth inhibition.

Further embodiments of the method for finding an inhibitor of iPGM include selecting one or more candidate inhibitors from: (i) a double-stranded RNA (dsRNA) library where the dsRNA is capable of gene silencing, (ii) from an antibody library or fragments of antibodies, (iii) from a small molecule library or (iv) from a natural extract library.

In an additional embodiment, a method is provided for treating a pathogenic infection in a host, wherein the pathogen has an iPGM for interconversion of 2-PG or 3-PG. The method includes: obtaining an iPGM inhibitor in a physiological formulation; and administering a therapeutically effective amount of iPGM inhibitor to the host for treating the pathogenic infection.

In an example of the above method of treatment, the host is a mammal, more particularly a companion mammal or a domestic mammal, more particularly, a human. Alternatively, the host is a plant. Examples of inhibitors include a dsRNA molecule of a size and sequence suitable for silencing an iPGM gene; an anti-iPGM antibody or fragment thereof suitable for inhibiting iPGM activity; a non-hydrolyzable substrate analog; an alkaline phosphatase inhibitor, for example, levamisole or hydroxy-4-phosphonobutanoate or a thiophosphate, thioester or seleno analog of 2-PG or 3-PG.

### BRIEF DESCRIPTION OF THE DRAWINGS

FIG. 1 is a diagrammatic representation of the bioinformatic approach for the identification of novel drug targets. (1) Genes with wild-type interfering dsRNA (RNAi) phenotype; (2) C. elegans genes, (3) Genes showing RNAi mutant phenotype that provides an important function, (4) essential non-mammalian genes, (5) mammalian genes; and (6) identify orthologs in parasitic nematodes and in Wolbachia.

FIG. 2 shows an outline of the glycolytic and gluconeogenic pathways that involve phosphoglycerate mutase (PGM).

FIG. 3 is a table summarizing the properties of dependent phosphoglycerate mutase (dPGM) and iPGM enzymes.

FIG. 4 is a venn diagram showing the overlapping and unique distributions of iPGM and dPGM in nature based on a survey of the completed genomes.

FIG. 5A is a schematic representing the alignment of parasitic nematode iPGM partial sequences with respect to the Caenorhabditis elegans (C. elegans) iPGM peptide.

For most indicated nematode species, multiple expressed sequence tag (EST) sequences were identified. The numbers in parentheses after each species indicate the GenBank ‘gi accession numbers’ of a non-redundant set of EST sequences giving the longest alignment to the C. elegans peptide.

The iPGM from C. elegans (gi 17507741) was used to query over 200,000 nematode partial gene sequences available in the GenBank EST database using the program TBLASTN. Candidate iPGM orthologs were those identified with a probability of <10exp⁻¹⁰. Thirty-eight non-C. elegans iPGM fragments were identified in a diverse set of nematodes including the following nematodes that infect the specified hosts:

humans: Ov, Onchocerca volvulus (5′ end, 7138173; 3′ end 2541844); B.m, Brugia malayi (5′ end, 1912539; 3′ end, 5510517); S.s, Strongyloides stercoralis (15774058); Trichinella spiralis (21817911); Necator americanus (23378783) animals; L.s, Litomosoides sigmodontis (6200684); O.o, Ostertagia ostertagi (14020275); H.c, Haemonchus contortus (11411129); Trichuris muris (27587871). plants: G.r, Globodera rostochiensis (7143657); M.i, Meloidogyne incognita (7797619, 7276048); H.g, Heterodera glycines (29049477, 29128654).

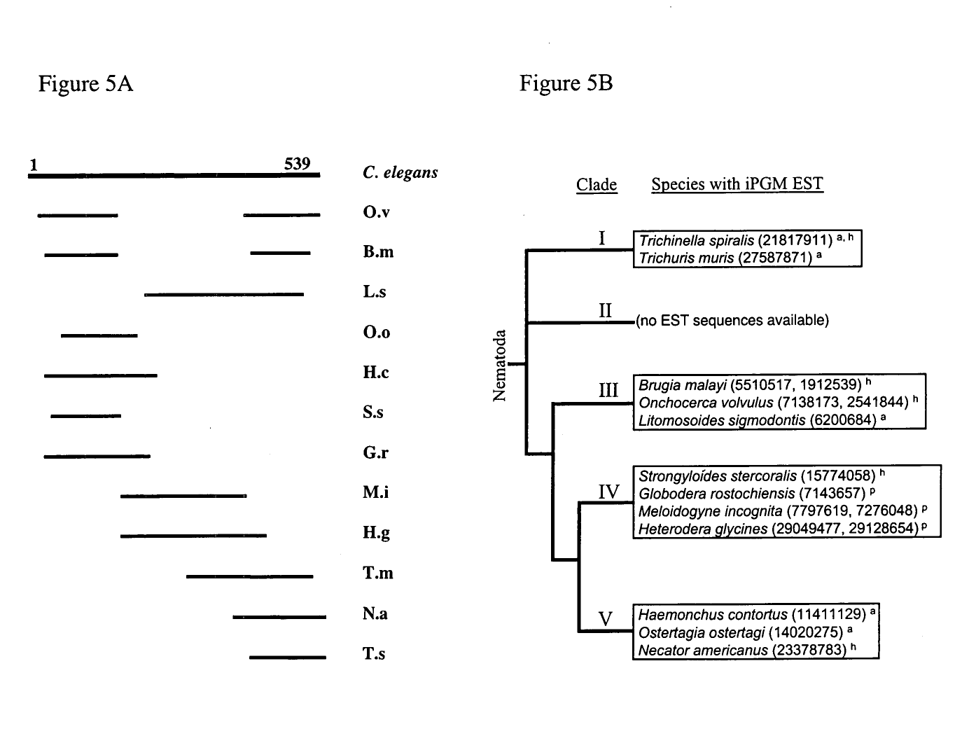

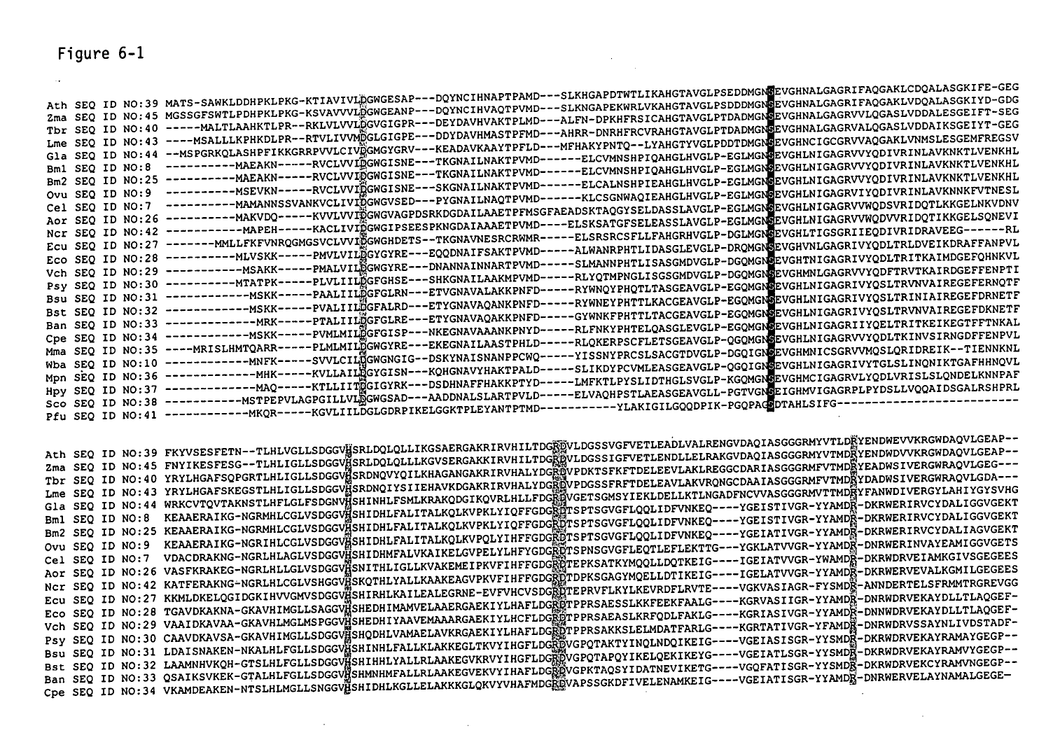

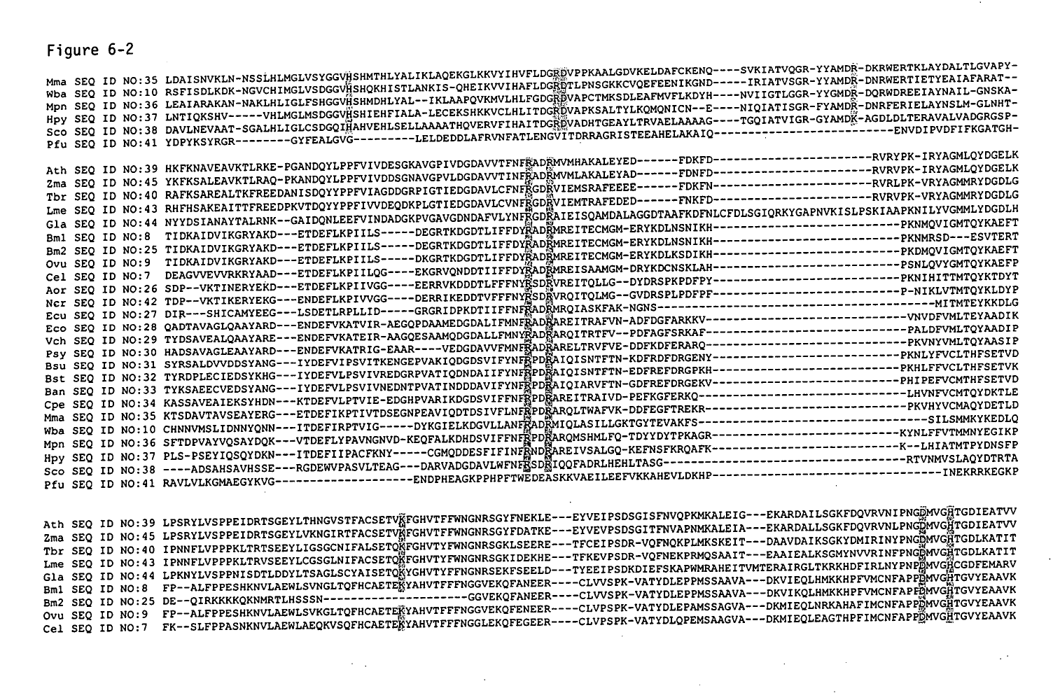

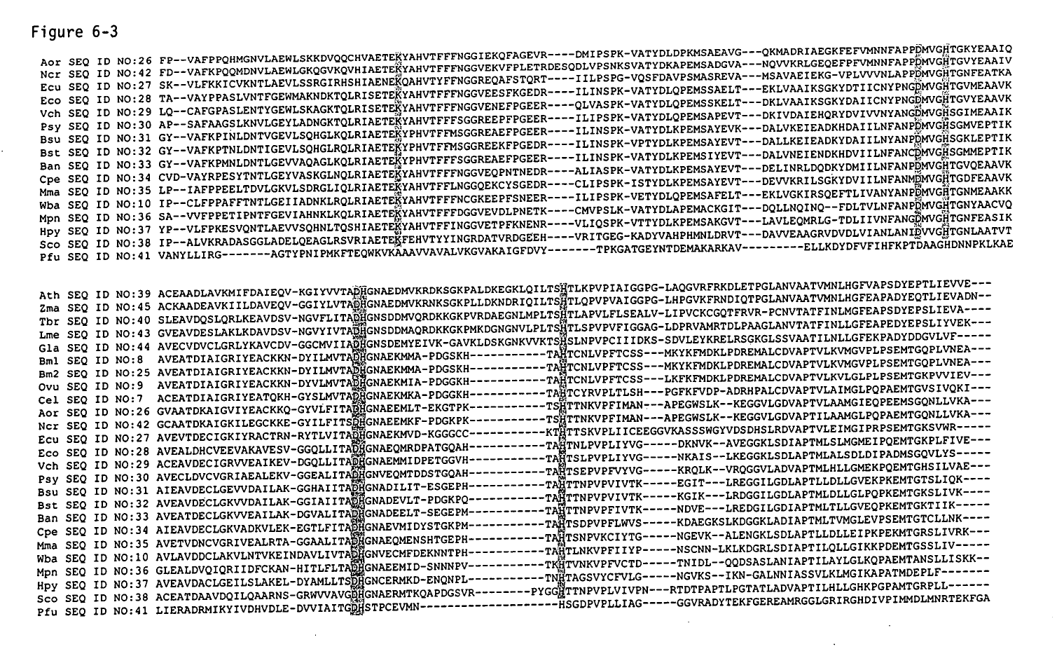

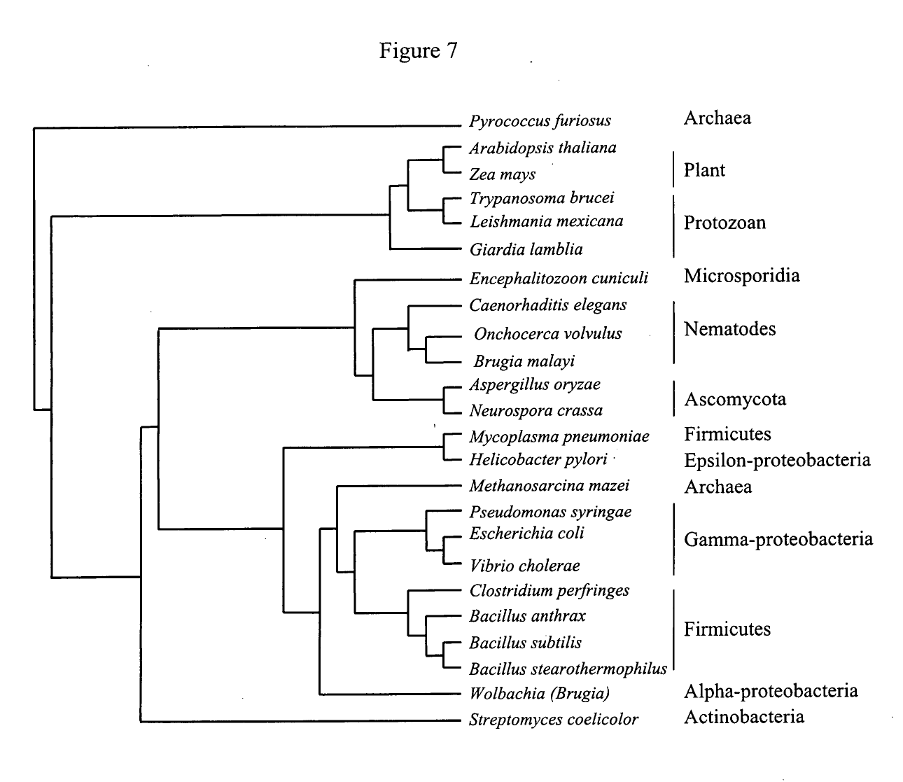

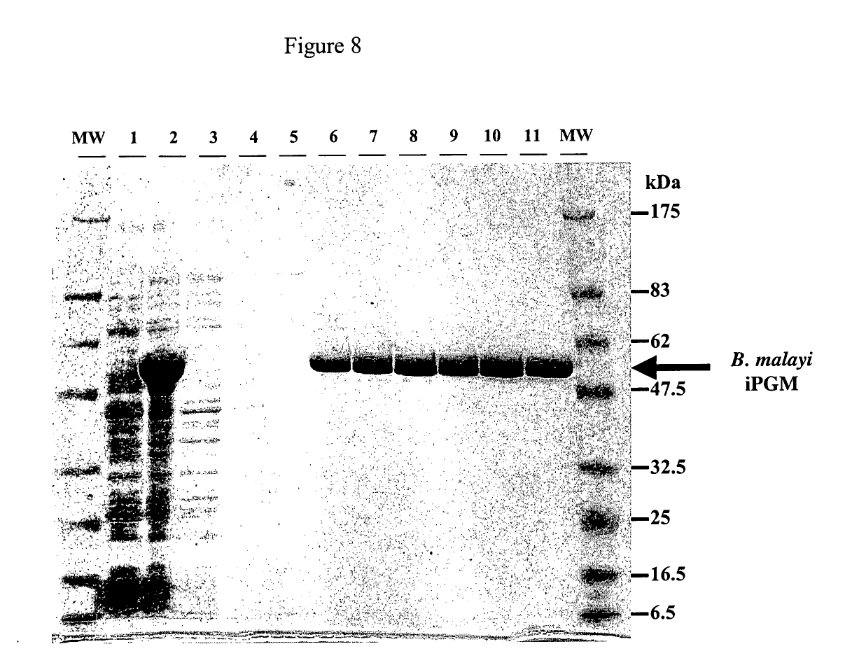

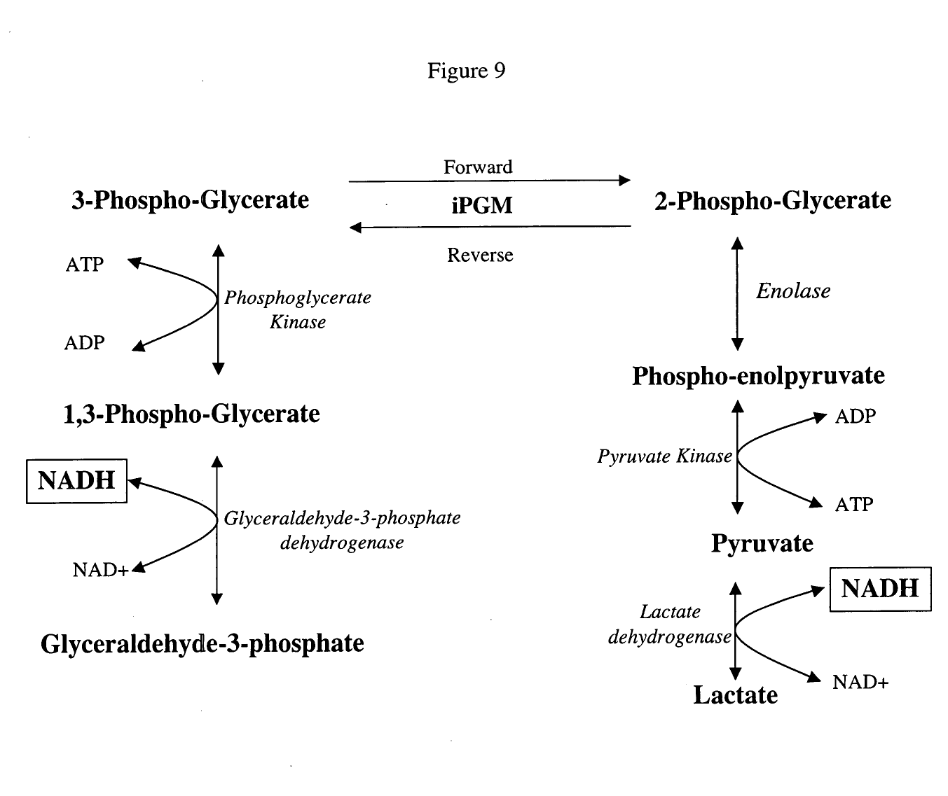

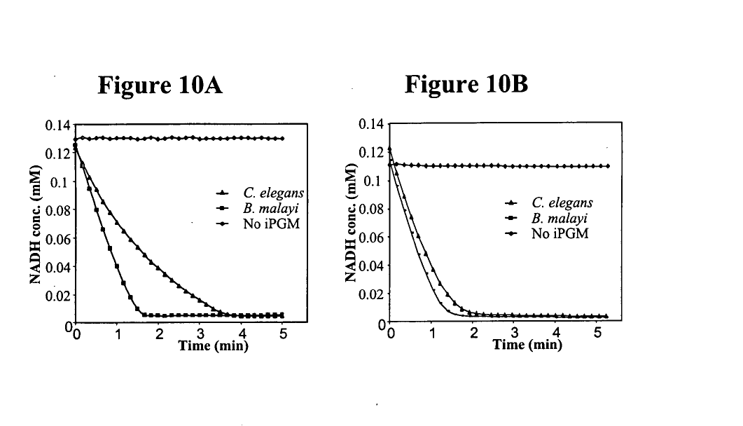

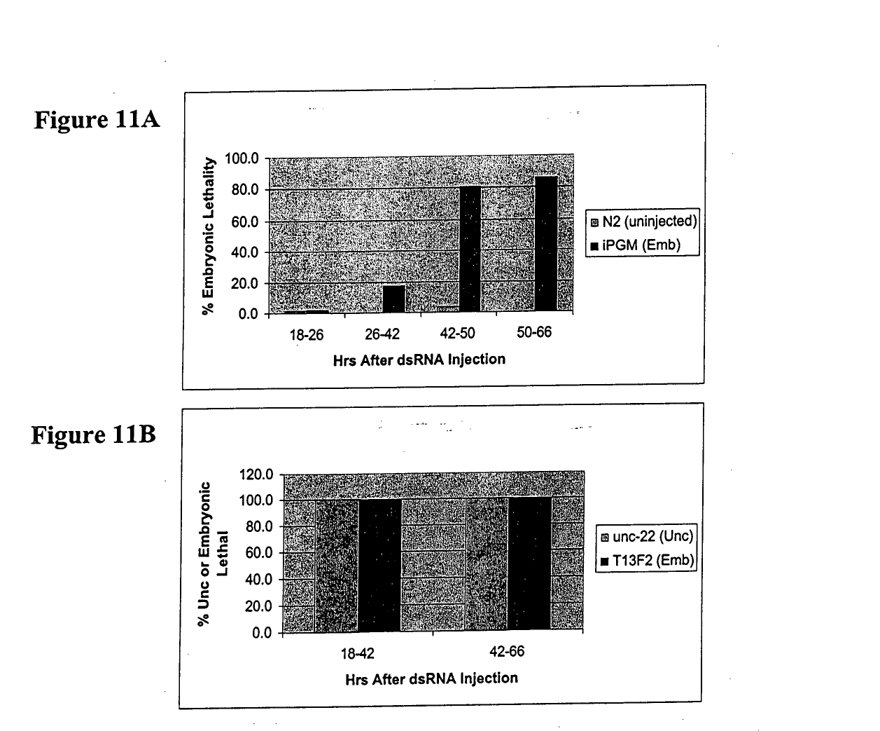

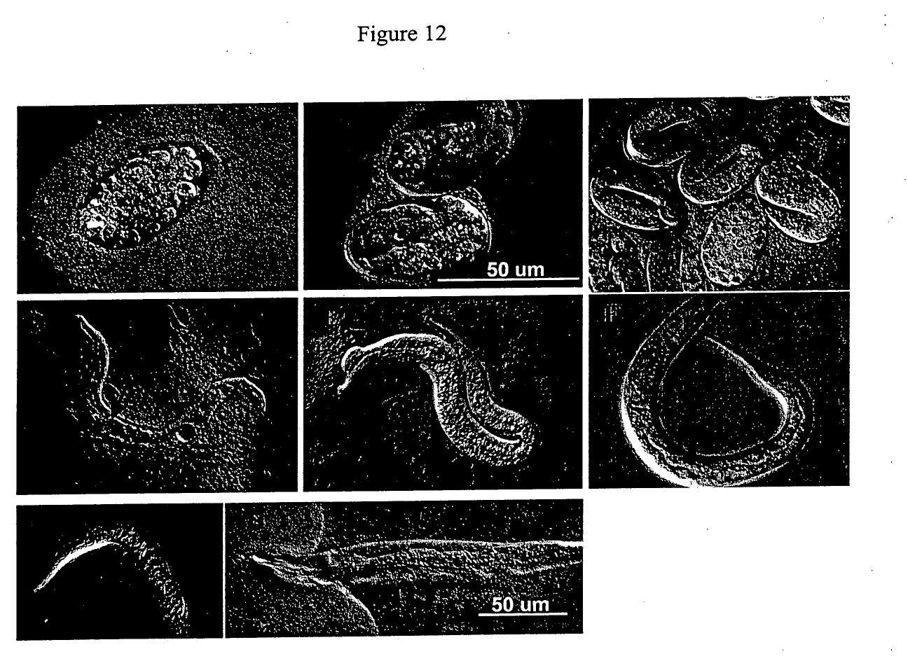

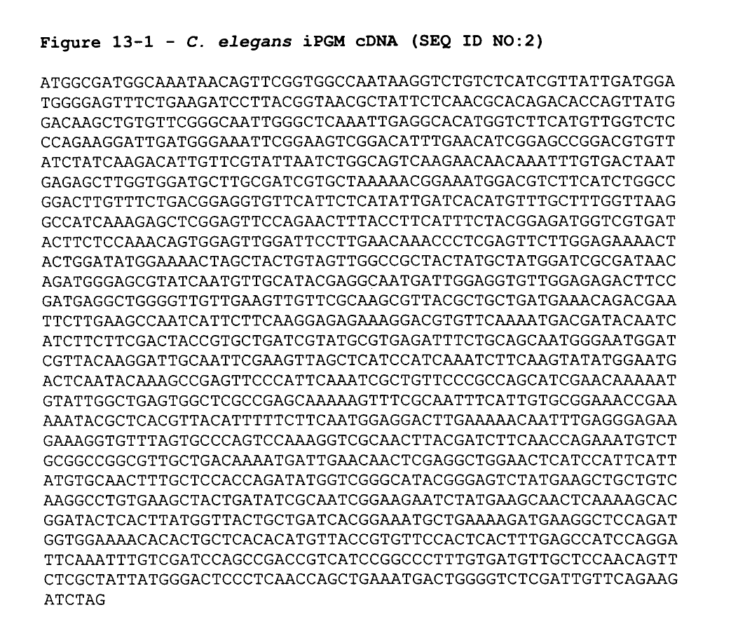

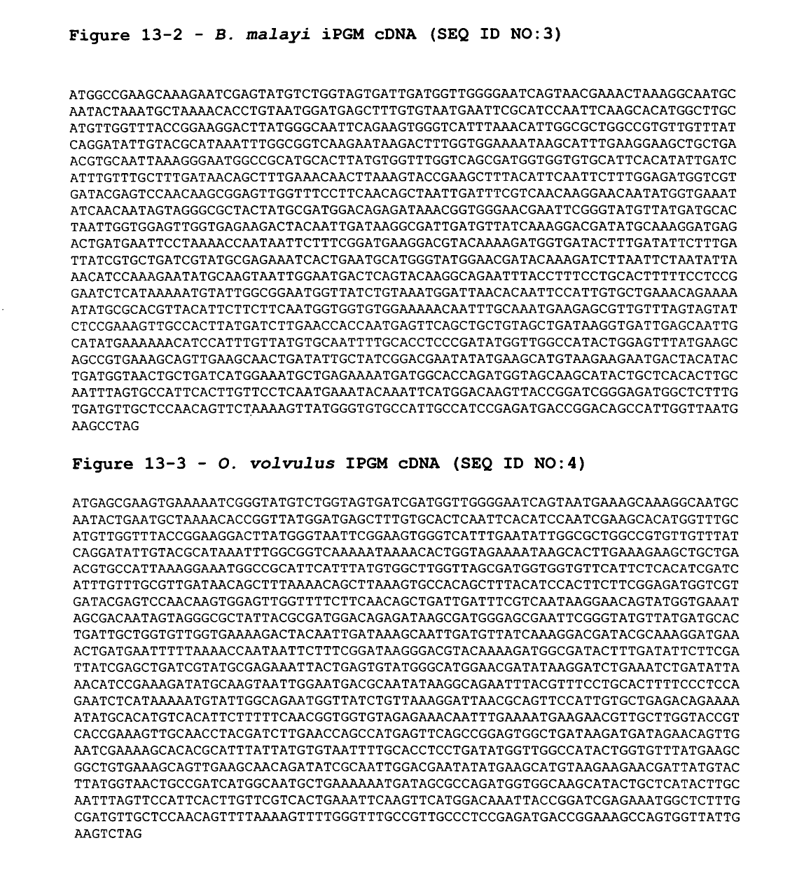

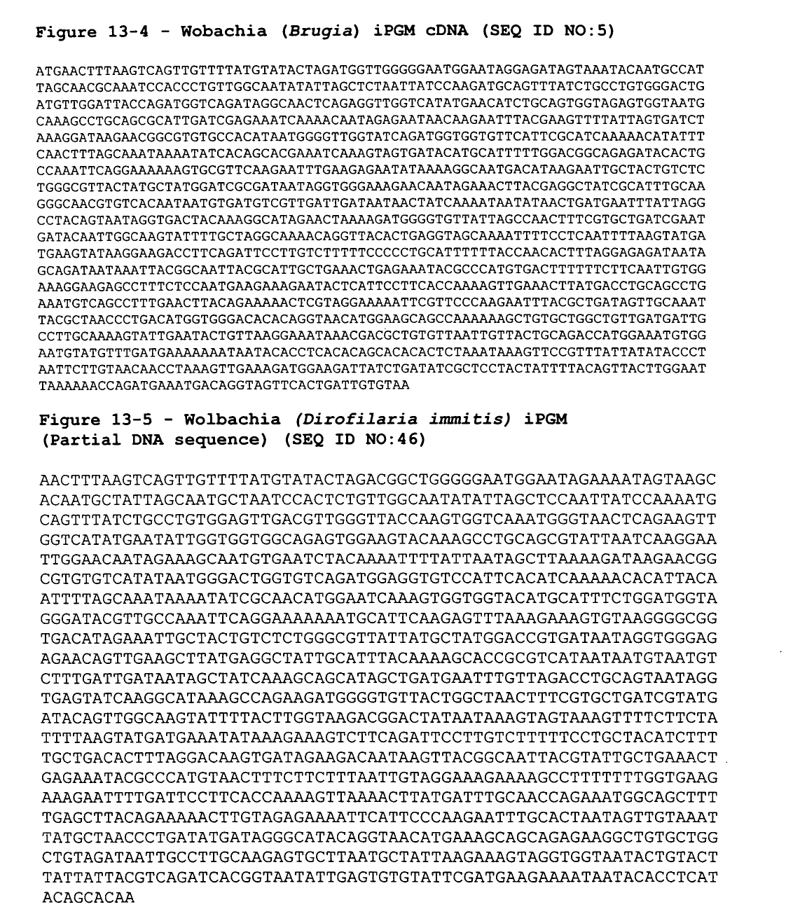

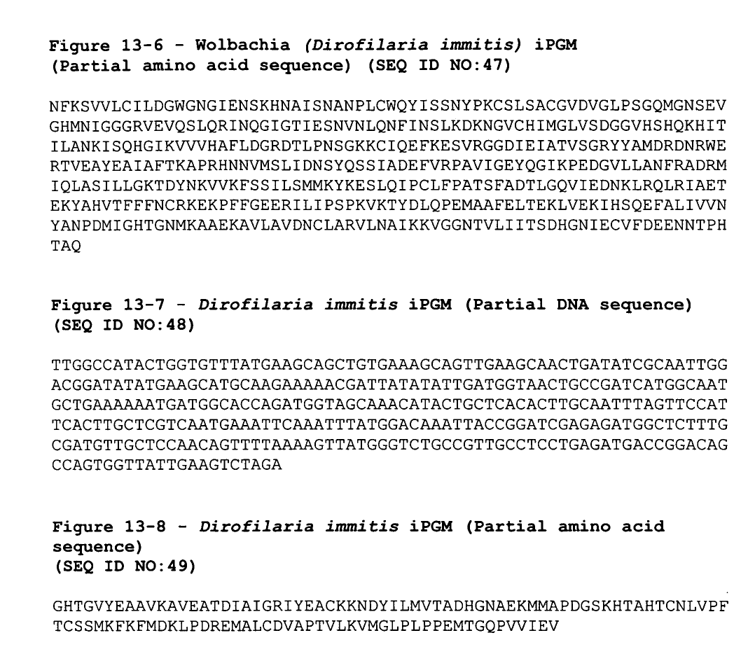

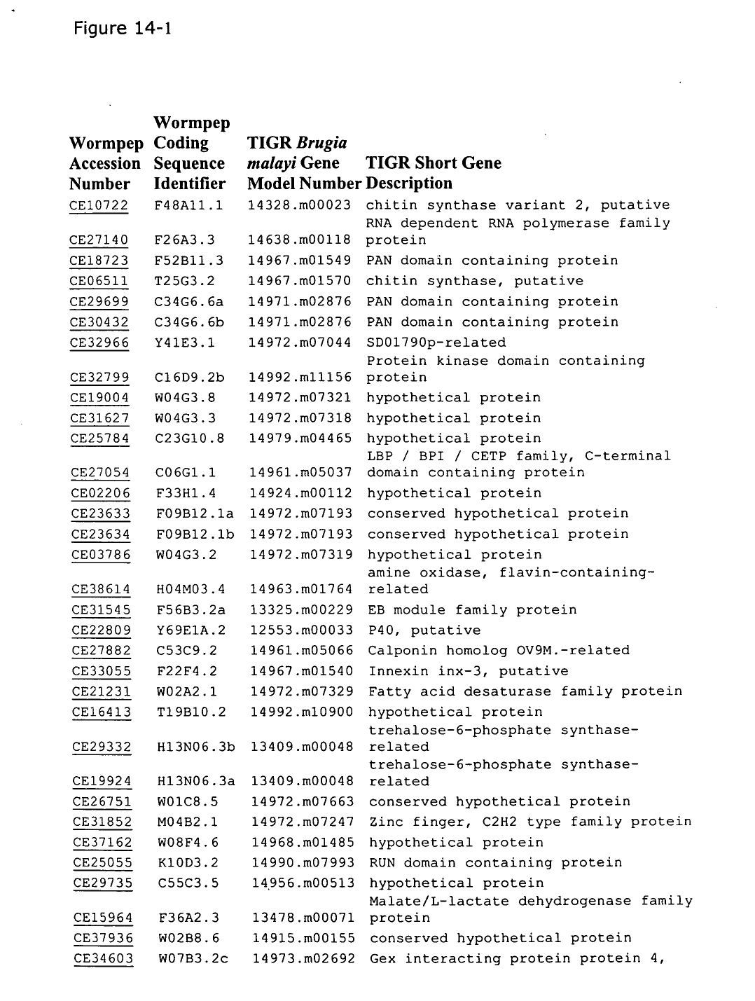

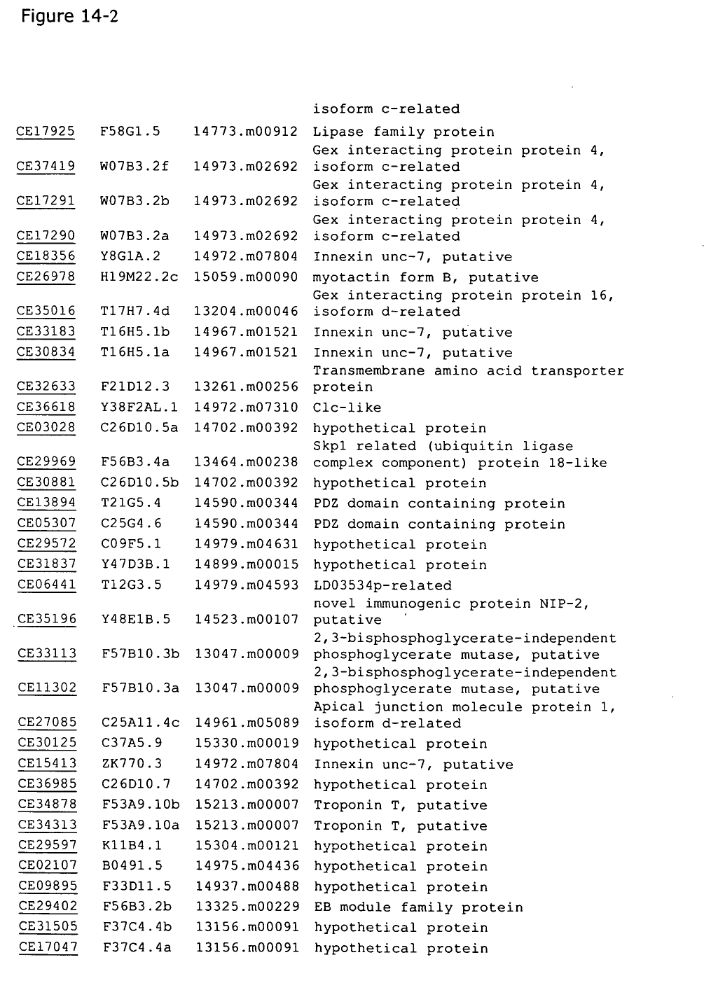

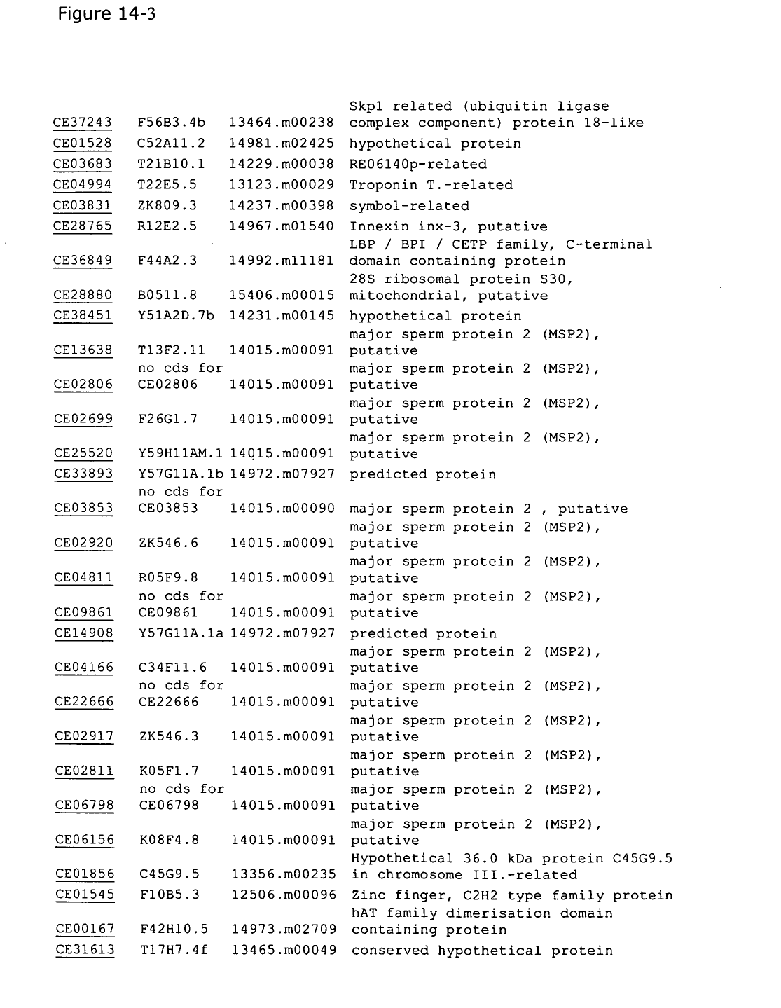

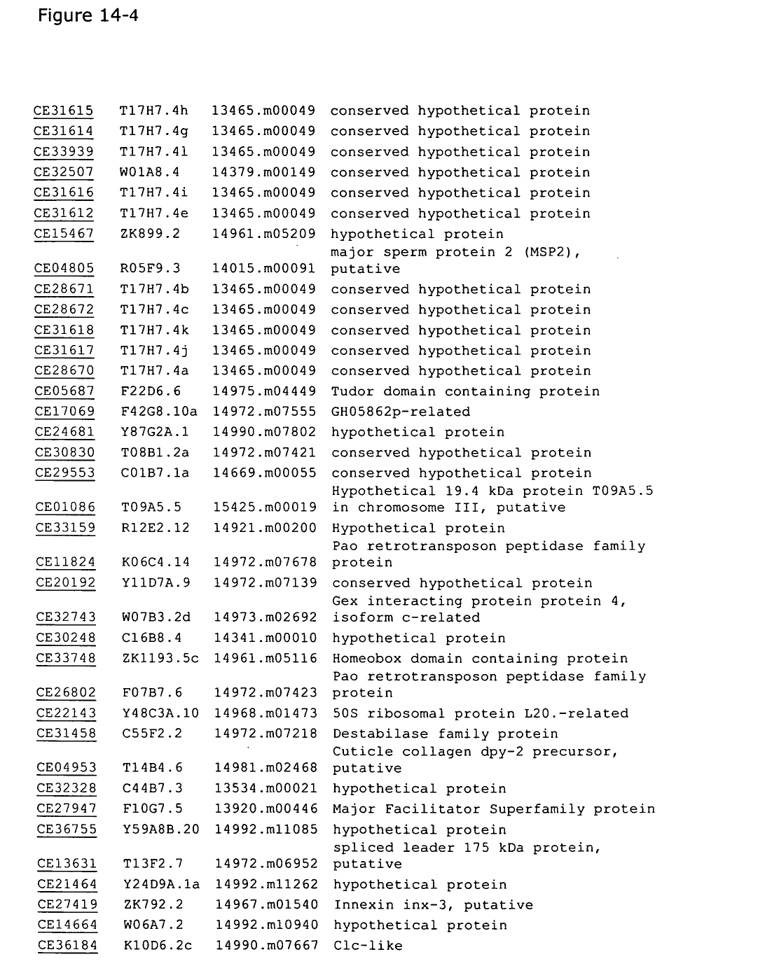

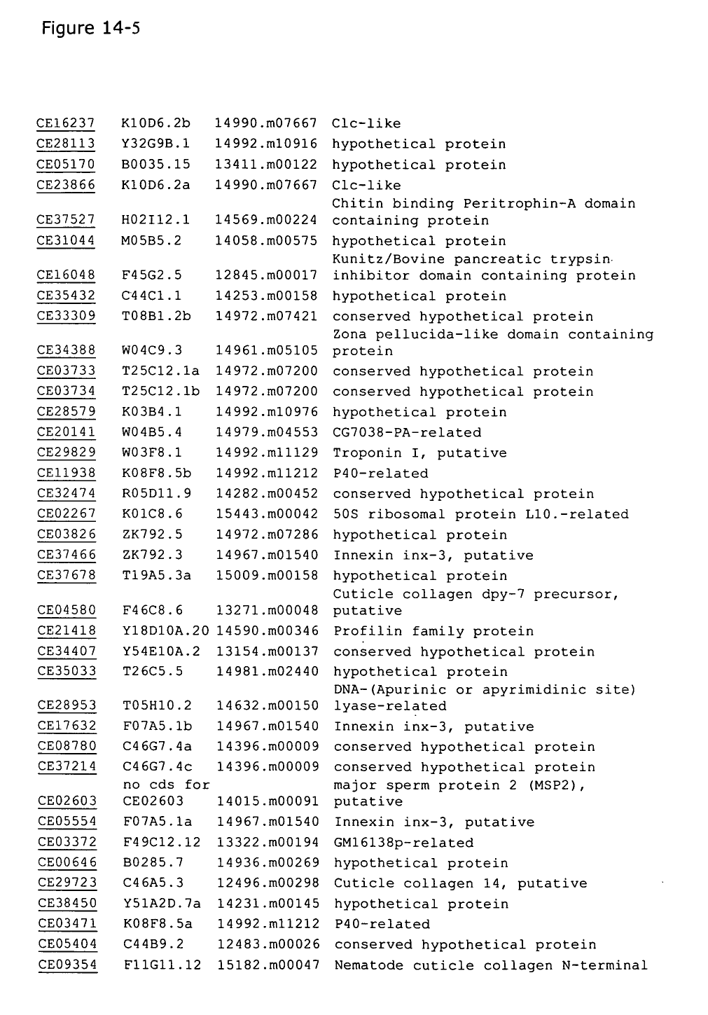

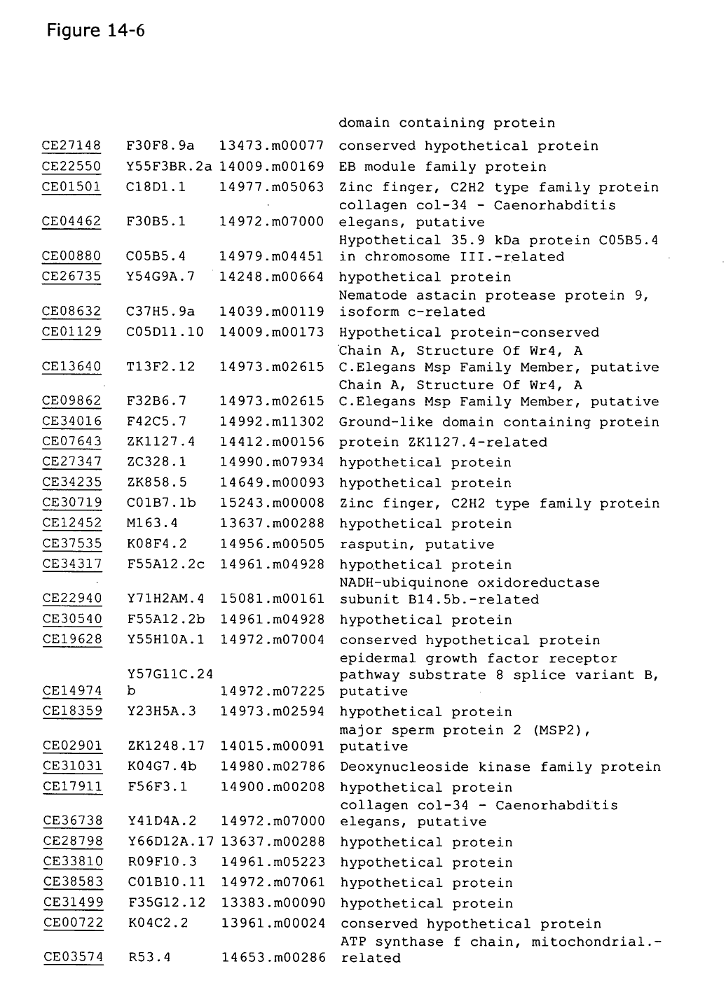

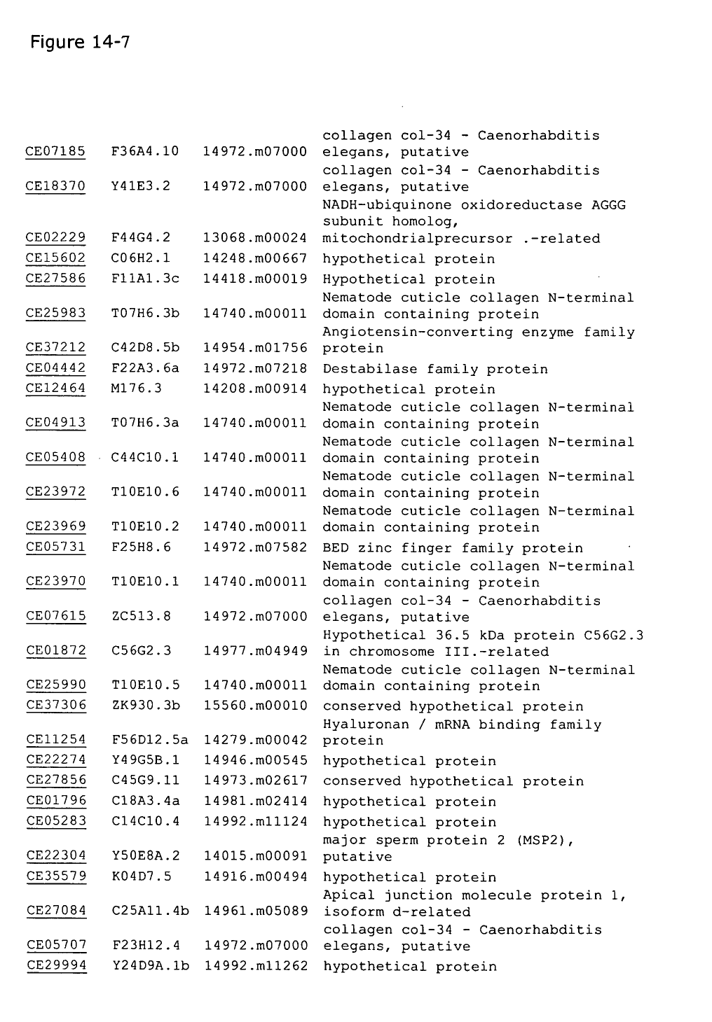

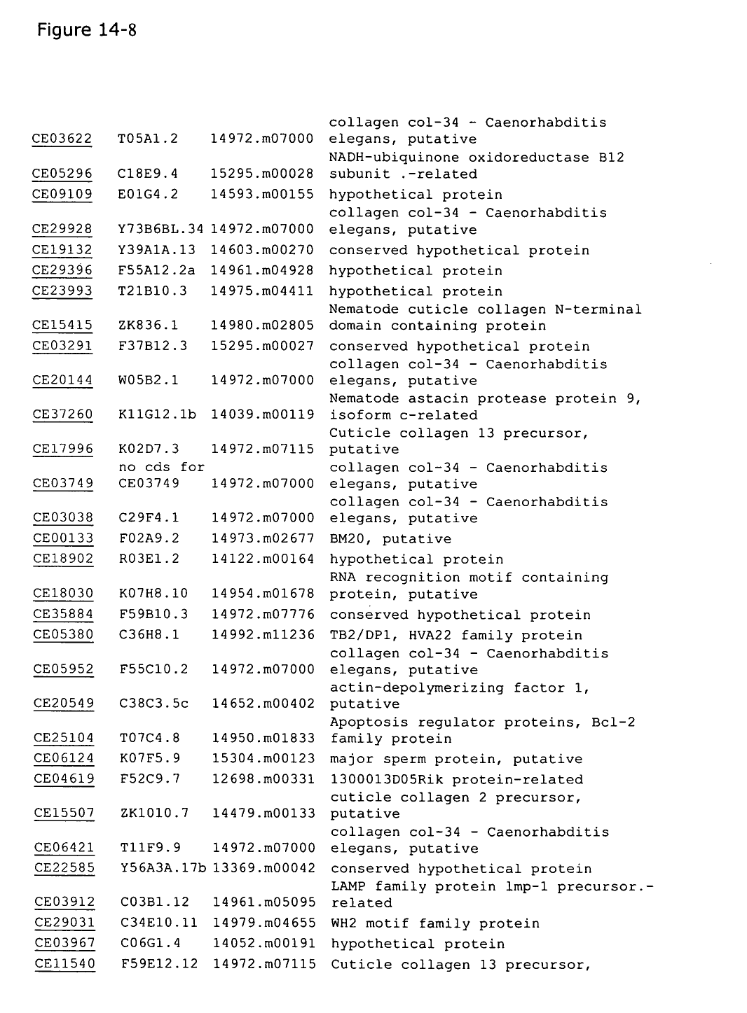

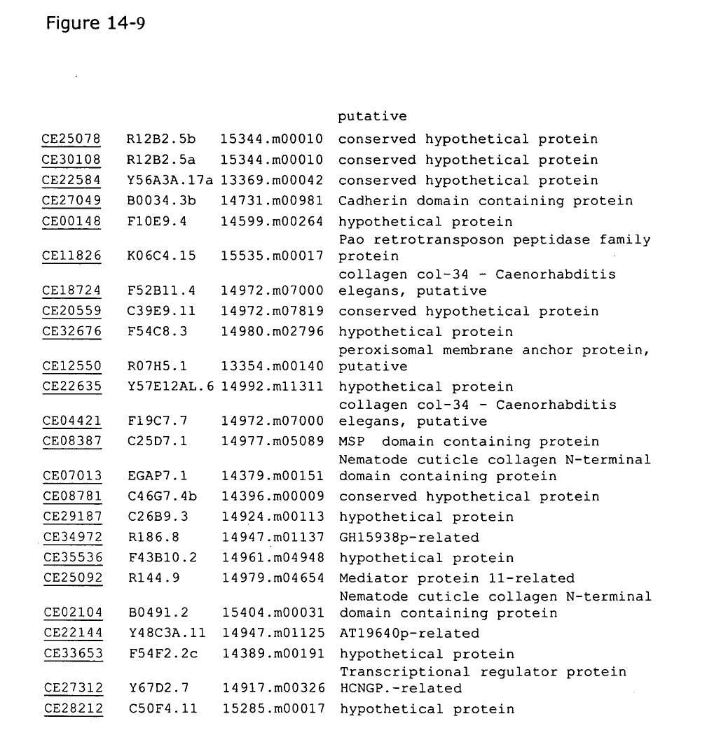

FIG. 5B shows a distribution of iPGM ESTs throughout the Phylum Nematoda. a-animal, h-human and p-plant parasites. The numbers in parenthesis are GenBank™ accession numbers.

FIG. 6 shows a sequence alignment of iPGM protein sequences from various organisms. iPGMs were selected from Table 1 to represent major classifications. Alignment was performed using ClustaIX (Thompson, J. D. et al., Nucleic Acids 25:4876-4882 (1997)). The degree of homology for a residue is indicated at the bottom of each residue, with an “*” indicating identity among all sequences, an “:” indicating some sequences have conservative changes and an “.” indicating less conservation among all sequences. The catalytic serine (black shade) and other active site residues (gray shade) as defined by crystallographic structure of B. stearothermophilus iPGM (Jedrzejas et al., EMBO J. 19:1419-1431 (2000)) are identical among all iPGMs. The abbreviations (GenBank accession numbers) are: Bm1 (AY330617) (SEQ ID NO: 8), Brugia malayi; Bm2 (AY330618) (SEQ ID NO:25), Brugia malayi, short isoform; Cel (gi27374479) (SEQ ID NO:7), the predicted short form that lacks the N-terminal 18 amino acids (MFVALGAQIYRQYFGRRG) of the predicted longer isoform, Caenorhabditis elegans; Aor (gi9955875) (SEQ ID NO:26), Aspergillus oryzae; Ecu (gi19074715) (SEQ ID NO:27), Encephalitozoon cuniculi; Eco (gi16131483) (SEQ ID NO:28), Escherichia coli; Vch (gi15640363) (SEQ ID NO:29), Vibrio cholerae; Psy (gi23471331) (SEQ ID NO:30), Pseudomonas syringae; Bsu (gi16080444) (SEQ ID NO:31), Bacillus subtilus; Bst (gi27734396) (SEQ ID NO:32), Bacillus stearothermophilus; Ban (gi21397599) (SEQ ID NO:33), Bacillus anthracis; Cpe (gi183102283) (SEQ ID NO:34), Clostridium perfringens; Mma (gi21227006) (SEQ ID NO:35), Methanosarcina mazei; Mpn (gi13508367) (SEQ ID NO:36), Mycoplasma pneumoniae; Hpy (gi15611975) (SEQ ID NO:37), Helicobacter pylori; Wba (AY330619) (SEQ ID NO:10), Wolbachia (from Brugia); Sco (gi21225111) (SEQ ID NO:38), Streptomyces coelicolor; Ath (gi18391066) (SEQ ID NO:39), Arabidopsis thaliana; Tbr (gi7380854) (SEQ ID NO:40), Trypanosoma brucei, Ovu (AY640434) (SEQ ID NO:9), Onchocerca volvulus; Pfu (ML82083) (SEQ ID NO:41), Pyrococcus furiosus; Ncr (gi3241168) (SEQ ID NO:42) Neurospora crassa; Lme (gi28400786) (SEQ ID NO:43) Leishmania mexicana; Gla (gi29250742) (SEQ ID NO:44) Giardia lamblia; Zma (gi168587) (SEQ ID NO:45) Zea mays.

FIG. 7 shows a phylogenetic tree of iPGMs from selected species. iPGMs used for the multiple sequence alignment in FIG. 6 are used to construct this phylogenetic tree using ClustaIX (Thompson, J. D. et al. Nucleic Acids Res. 25:4876-82 (1997)). The iPGM from Pyrococcus furiosus is most distantly related to the C. elegans query and was used as the out-group.

FIG. 8 shows the overexpression and purification of recombinant iPGM B. malayi. Lane 1, total protein lysate from un-induced cells; Lane 2, total protein from IPTG induced cells; Lane 3, flow through from Nickel-chelating column; Lanes 4-5, wash from Nickel-chelating column with 10 and 20 mM Imidazole; Lanes 6-11, sequential fractions eluted from Ni column with 60 mM Imidazole. The arrow marks the B. malayi band at molecular weight between 62 and 47.5 kDA.

FIG. 9 is a schematic illustration of the assay for measuring PGM activity in the glycolytic (3-PG to 2-PG) and gluconeogenic (2-PG to 3-PG) directions.

FIGS. 10A and 10B show the PGM activity of recombinant nematode iPGMs. Typical progress curves are shown for B. malayi iPGM activity in the glycolytic (3-PG to 2-PG) and gluconeogenic (2-PG to 3-PG) directions in FIGS. 10A and 10B, respectively. In both reactions, PGM activity was determined indirectly by measuring a decrease in the absorbance of NADH at 340 nm. The consumption of NADH is directly proportional to PGM activity. Baseline, no iPGM added.

FIGS. 11A and 11B show the time course of the effect of RNAi inactivation of iPGM in C. elegans (FIG. 11A), unc-22 or T13F2 (FIG. 11B) in C. elegans. FIG. 11A shows a timecourse of C. elegans iPGM RNAi on embryo lethality. FIG. 11B shows a timecourse of C. elegans RNAi on embryo lethality. The data from Table 2 were used for this graph. The data from individual worms injected with either 1 mg/ml or 3 mg/ml dsRNA are summarized in FIG. 11A. The RNAi data in FIG. 11B for unc-22 and T13F2.2 were obtained from different experiments following similar injections of dsRNA.

FIG. 12 shows the effects of disrupting iPGM by RNAi on nematode development and survival. DIC images of abnormal embryos and larvae resulted from RNAi knockdown of Ce-iPGM. Embryos that failed to hatch arrested at various stages such as shown in (A) an early or (B) a late stage and arrested embryos showed abnormal appearance compare to normal embryos at similar stages (C). Variable abnormal body morphologies in larvae were seen as shown in (D), a larva displaying extensive degenerating intestine cells (arrows), and in (E), a larva displaying a bump (arrow head) on its anterior region with relatively normal appearance in the rest of the body as seen in wild type larva (F). Some larvae arrested at L1 (G) or die (H). Images A-C were taken with a 63× objective and D-H with a 40× objective.

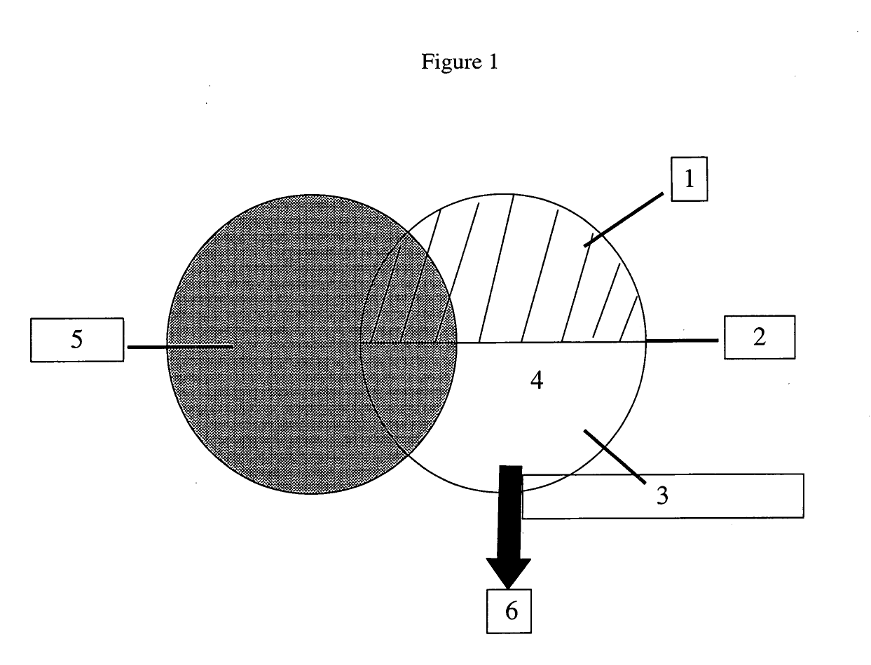

FIG. 13 shows sequence listings of the cloned cDNA sequences corresponding to iPGM genes from B. malayi, O. volvulus, and C. elegans (FIGS. 13-1, 13-2, 13-4), Wolbacchia (brugia) (13-3) and Wolbacchia (D. immitis) partial DNA sequence 13-5 and protein partial sequence 13-6 and D. immitis (DNA partial sequence) 13-7 and (protein partial sequence) 13-8).

FIG. 14 is a list of potential drug targets in Brugia malayi resulting from the computational methods described in Example 11.

### DETAILED DESCRIPTION OF EMBODIMENTS

Certain terms have been defined below. These definitions are intended to be used herein unless the context requires otherwise.

The term “pathogen” or “pathogenic organism” includes a disease causing organism, a parasite, a symbiont of a pathogen, an agricultural pest, or a disease vector.

The term “microbial pathogen” includes pathogens that are bacteria, mycoplasma and microsporidia.

The term “ranking order” refers to a classification in order of significance as a drug target of a pathogen.

The term “relative homology” is intended to describe the similarity of iPGM amino acid or DNA sequences from different sources. Where the relative homology is high, the protein target from different organisms might be inhibited by the same inhibitor, which would enhance the utility of that target over those targets where there is a significant amount of variability between different sources.

The term “hybridization under stringent conditions” refers to standard conditions for identifying individual gene sequences using short nucleotide probes (greater than about 15 nucleotides, see for example J. Sambrook, et al., Molecular Cloning: A Laboratory Manual, 11.42-11.61, Cold Spring Harbor Laboratory Press, Cold Spring Harbor, N.Y., (1989). Stringent hybridization conditions include a solution containing 6×SSC, 0.5% SDS at room temperature.

The term “Genome wide RNA gene silencing database” refers to a collection of results from RNAi experiments where each RNAi experiment targets a gene in the genome of a target organism. For example, the genome wide RNA gene silencing database for C. elegans consists of experiments where RNAi has been carried out using DNA fragments incorporated in plasmids under opposing promoters (for example T7 promoters) and the plasmids introduced into bacterial cells such as E. coli where different clones produce dsRNA to different genes. The bacterial clones can then be provided as food to C. elegans so that the dsRNA produced by the bacteria is ingested by C. elegans and can cause a change of phenotype. Alternatively, dsRNA molecules can be injected into C. elegans or C. elegans can be soaked in a preparation of dsRNA molecules. Changes in phenotype can be investigated by visual inspection, which reveals lethality, abnormal movement or changes in development.

A computational method using a genome wide search conducted in silico was developed for identifying one or more proteins suitable for use as a target in discovering inhibitors for treating pathogenic organisms. Genes encoding potential drug targets were selected according to (a) whether the gene was present in the pathogen but not in the host and (b) according to phenotypic criteria. The search methodology (illustrated in FIG. 1) has been validated according to Example 1 by its use in identifying a drug target identified as cofactor iPGM.

In an embodiment of the invention, a genome wide RNA gene silencing database that contains RNAi data from 16,755 genes (about 86% of the genome) was used to find 1,851 genes that gave a non-wild type phenotype. 370 of these genes were identified as non-mammalian. Of these, 192 genes were found in nematodes additional to C. elegans. From these, applicants selected a single gene product, namely, iPGM, for further analysis as a drug target.

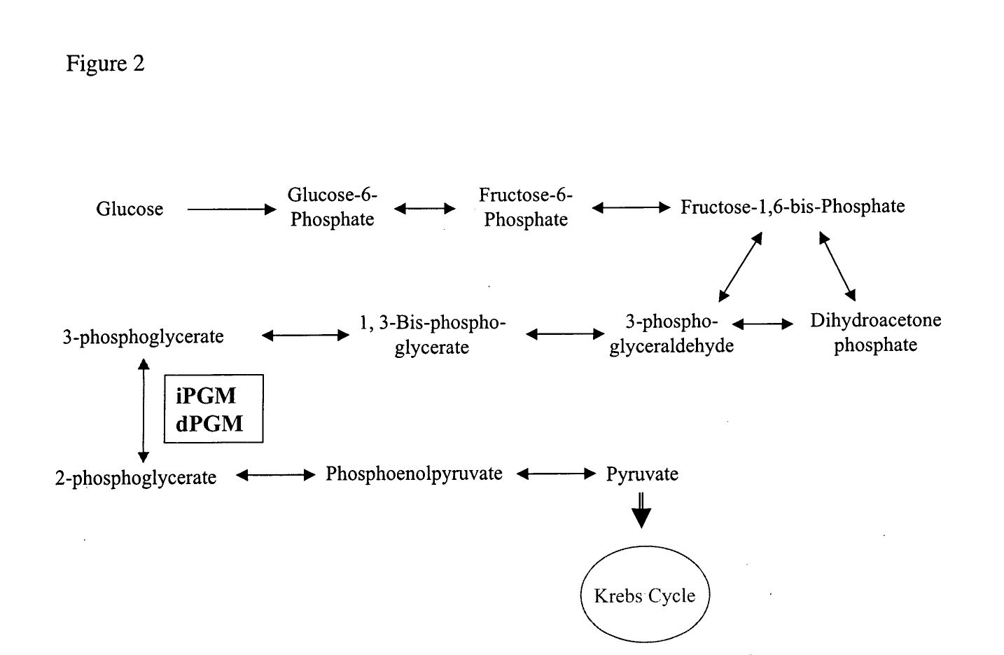

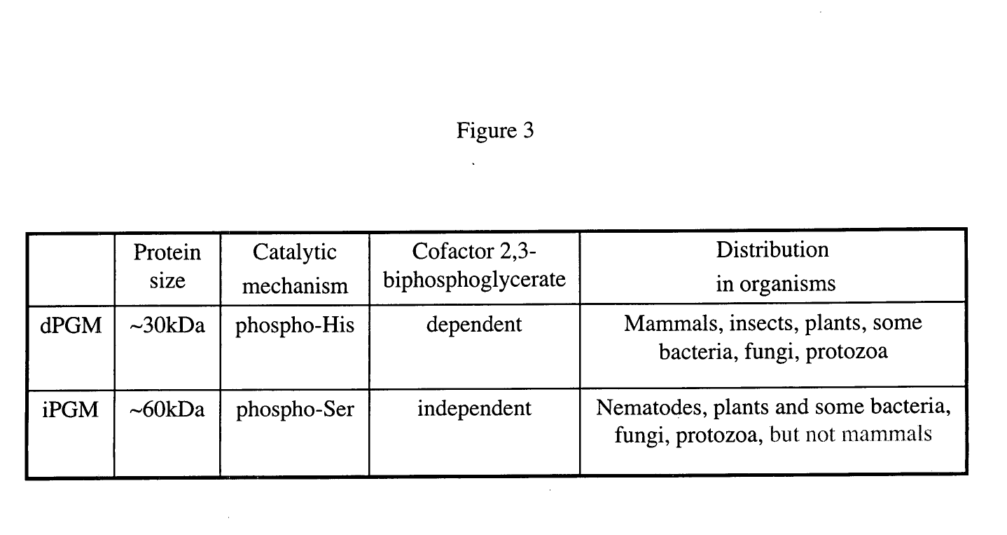

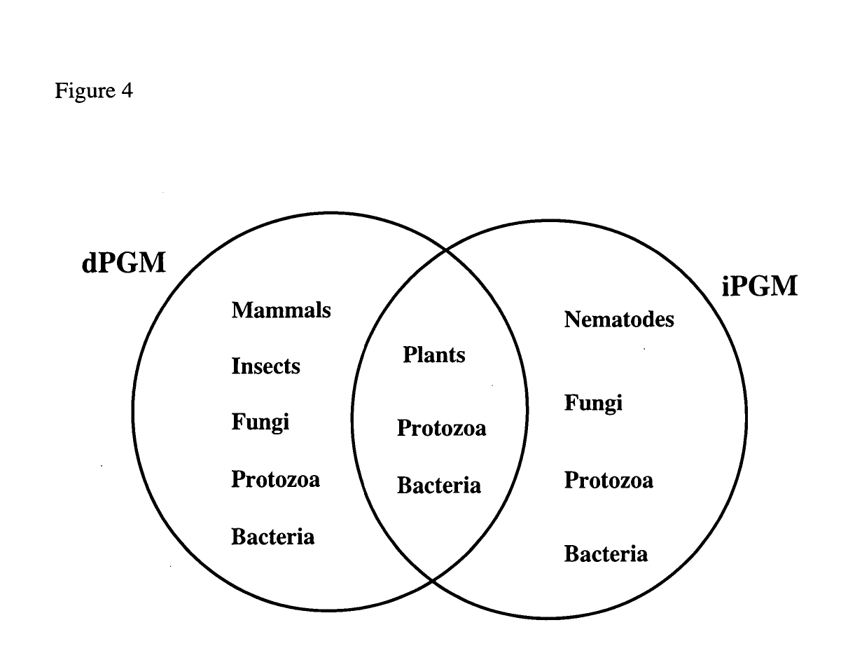

PGM plays a role in glycolytic and gluconeogenic metabolic pathways (illustrated in FIG. 2). PGM exists in two different forms in nature, which are identified as cofactor dPGM and cofactor iPGM (summarized in FIG. 3, Table 1). Some organisms have both forms while others have one form only (illustrated in FIG. 4, Table 1).

Subsequent to the identification of PGM as a potential drug target by the computer method described herein (FIG. 1, Example 1), a wide range of organisms were analyzed to determine whether there was in fact, a unifying principle in the distribution of iPGM (see Example 3 and FIG. 4). Putative sequence for C. elegans iPGM (gi 17507741; 539 aa) and human dPGM (gi 130353; 253 aa) were used to query completed genome sequences in GenBank using the BLASTP program. Selected likely orthologs with BLASTP scores higher than 60 are listed in Table 1. During this analysis, it was found that while Bacillus subtilis has iPGM only, Bacillus anthracis has both iPGM and dPGM, an observation that supports the previously described unpredictability of occurrence of this molecule. Likewise, Streptomyces avermitilis has dPGM while S. coelicolor has both iPGM and dPGM. Also Clostridium acetobutylicum has both forms, whereas C. perfringens has only iPGM.

Interestingly, it was found that the microsporidia Encephalitozoon cuniculi which is an HIV opportunist has only iPGM as does Mycoplasma pneumonia which causes pneumonia and Clostridium perfringens which causes botulism (Table 1). Table 1 also shows that Wolbachia symbionts from Brugia have iPGM but not dPGM. Likewise, Pseudomonas spp., Vibrio spp., Campylobacter jejuni, Giardia lamblia, Helicobacter spp., Coxiella burnettii, Leptospira iterrogans, Agrobacterium fumefaciens, Ureaplasma urealyticum, Trypanosoma spp, Entamoeba histolytica, Leishmania mexicana, Giardia lamblia, Cryptococcus neoformans, Aspergillus oryzae, Mycoplasma spp., possess only the iPGM form.

The analysis described above revealed an apparently haphazard occurrence of iPGM in microbial pathogens, fungi, protozoa and arthropods. In contrast, a surprising consistency was discovered among the pathogenic nematodes. The C. elegans iPGM peptide (gi 17507741; 539 aa) was used to search for nematode orthologs from amongst over 200,000 publicly available nematode gene fragments available in GenBank's EST database using the TBLASTN program. FIG. 5A shows the alignment of gene fragments from 12 nematode species that were found to have DNA encoding iPGM with a probability more significant than 1 exp 10⁻¹⁰. These include species, which infect humans (Onchocerca volvulus, Brugia malayi, Strongyloides stercoralis, Trichinella spiralis, Necator americanus), animals (Litomosoides sigmodontis, Ostertagia ostertagi, Haemonchus contortus, Trichuris muris) and plants (Globodera rostochiensis, Meloidogyne incognita, Heterodera glycines). When the presence of dPGM was tested, the results were in all cases negative. The consistency of occurrence of iPGM in all nematodes has been established (for example, see FIG. 5B).

iPGM is a useful target for treating pathogens and pests and provides a new approach to finding therapeutic agents against various important diseases caused by the pathogens. Moreover, since it is not known if dPGM can compensate for any iPGM deficiency, iPGM still represents a valid drug target in those organisms which have both forms listed in Table 1, namely, Bacillus anthracis, Trichomonas vaginalis, Staphylococcus spp., Listeria monocytogenes, Shigella flexneri, Salmonella spp. and Yersinia pestis.

Polynucleotides Encoding iPGM

The iPGMs identified in the above searches were aligned by their amino acid sequences and a conserved motif was identified (SEQ ID NO:6).

| | |
|---|---|
| MGNSEVGHLNIGAGRVVYQ | (SEQ ID NO:6) |

The conserved nucleotide sequence corresponding to SEQ ID NO:6 was used to define a class of iPGMs that is capable of hybridizing under stringent conditions to the following:

| | |
|---|---|
| ATGGGCAATTCAGAAGTGGGTCATTTAAACATTGGCG | (SEQ ID NO:1) |
| CTGGCCGTGTTGTTTATCAG | |

Surprisingly, parasitic nematodes as a whole contained iPGM rather than dPGM and the iPGM in this group shared at least 60% identity, more particularly 70% identity, more particularly 80% identity to this DNA sequence. It was concluded from the findings of Example 1 and FIG. 6 that iPGM having nucleotide sequence identity to SEQ ID NO:1 as described above is a suitable target for developing inhibitors against parasitic nematodes and infections caused by the same. More generally, any iPGM sequence from any pathogenic organism sharing at least 50% identity, more particularly 60% identity, more particularly 70% identity, more particularly 80% identity to this sequence is a suitable target for developing inhibitors against that pathogen and infections caused by the same.

In a preferred embodiment of the invention, any parasitic nematode iPGM sharing at least 70% amino acid identity, more particularly 80% identity to this amino acid sequence is a suitable target for developing inhibitors against parasitic nematodes and infections caused by the same. Furthermore, a pathogenic organism iPGM peptide sharing at least 60% identity, more particularly 70% identity, more particularly 80% identity to this sequence is a suitable target for developing inhibitors against that pathogen and infections caused by the same.

Members of this class include DNA encoding iPGM from C. elegans, Brugia malayi, O. volvulus and Wolbachia (Brugia). The substantially complete DNA sequences encoding these iPGMs are provided in FIG. 13-1, while the substantially complete amino acid sequences for these proteins are provided in FIG. 6 along with the amino acid sequences of other related iPGMs that have been isolated and compiled in FIG. 6. Partial DNA and amino acid sequences are provided for Wolbachia (Dirofilaria immitis) and D. immitis in FIG. 13 (13-5-13-8).

Computational Approach to Identifying Candidate Drug Targets.

In an embodiment of the invention, a multi-step, integrated computational method was developed for performing a systematic, genome-wide search for novel drug targets in parasitic nematodes (Example 1 and FIG. 1). This was achieved by a computer based selection methodology involving the output of a series of computational steps performed by one or more programs running on a computer. The results from one step formed the input data for subsequent steps. It was determined that steps in the analysis might include any of or all of the following: comparison of the similarity between two gene or protein sequences; classification of gene or protein sequences based on data from a previous step, a predefined value, or another data source; and screening or filtering the output of a previous step using predefined values or data from another data source. Example 1 describes an example of the above.

The genome of the free-living nematode, C. elegans, has been completely sequenced and there is a substantial classic genetic database as well as a genome-wide RNA interference database. In addition, C. elegans is relatively straightforward to cultivate. Although parasitic nematodes and free-living nematodes grow and thrive in widely different environments, the free-living model organism C. elegans nonetheless shares some of the essential developmental processes and structural features of the parasitic nematodes which in turn is reflected in homology of certain proteins. For the above reasons, C. elegans was selected as a model organism to identify potential new drug targets in parasitic nematodes.

The computational methodology described herein takes advantage of the results from large-scale phenotypic analyses (RNAi screens) performed in C. elegans, which are available in Wormbase (www.wormbase.com).

The subset of proteins identified by the computational method as necessary for normal development and survival in C. elegans were subjected to a BLAST analysis (Altschul, S. F. et al. Nucleic Acids Res. 25:3389-402 (1997)) to determine which members of this subset occurred in mammalian genomes (human and mouse). Those proteins in the subset with mammalian homologs were then excluded. The remaining proteins in the data set were consequently non-mammalian. The sequences encoding these proteins were compared to EST sequences from several filarial nematodes. Additionally, analyses were performed to determine the presence of selected candidate protein targets in Wolbachia endosymbionts. These proteins were analyzed further and ranked based on their suitability as drug targets and the desirability of their associated RNAi phenotype with respect to controlling worm development.

The final data set included potential targets that (i) possessed an RNAi-detectable phenotype in C. elegans and are present in parasitic nematodes or their symbionts, but (ii) were not present in mammals.

iPGM is a Candidate Drug Target

The above computational method revealed that iPGM is a candidate drug target which met the above stated requirements, namely that (i) the potential target possessed an RNAi-detectable phenotype in C. elegans and was present in parasitic nematodes or their symbionts, and (ii) but not present in mammals. PGM is a key enzyme in the glycolytic and gluconeogenic pathways (FIG. 2) responsible for the interconversion of 2-PG and 3-PG (Fothergill-Gilmore, L. A., Watson, H. C. Adv Enzymol Relat Areas Mol. Biol. 62:227-313 (1989)).

Two distinct types of PGM are known to exist; one requires the cofactor 2,3-diphosphoglycerate for activity (dPGM), while the other does not (iPGM). There is no protein sequence homology between dPGM and iPGM indicating that they may have arisen independently during evolution. A number of other characteristics also distinguish dPGM from iPGM (summarized in FIG. 3). The dPGM enzymes are members of the acid phosphatase superfamily. They exist as monomers, dimers or tetramers of a ˜27 kDa subunit. iPGMs are members of the alkaline phosphatase superfamily (Galperin et al. Protein Science 7:1829-1835 (1998)) and they are large monomeric proteins of ˜60 kDa in size. Certain iPGMs may require particular cations and pH for optimal activity. The 2 enzymes also differ in their mechanisms of action. The dPGM catalyzes the intermolecular transfer of the phosphoryl group between the monophosphoglycerates and cofactor, with a phosphorylhistidine as an intermediate (Rigden, D. J. et al. J. Mol. Biol. 315:1129-1143 (2002)). In contrast, the iPGM catalyzes the intramolecular transfer of the phosphoryl group between the two hydroxyl groups of the monophosphoglycerates, with a phosphoserine intermediate (Jedrzejas, M. J. et al. EMBO J. 19:1419-1431 (2000)). The activity of dPGM is inhibited by vanadate, whereas iPGM is insensitive to this agent. iPGMs have previously been identified in extracts prepared from a number of different organisms (Carreras, J. et al. Comp Biochem Physiol. 71B:591-7 (1982)) and in some cases the enzyme has been partially purified from bacteria such as Bacillus, Sporosarcina and Clostridium species (Chander, M. et al. Can J Microbiol. 44:759-767 (1998), Kuhn et al. Arch Biochem. Biophysics 306:342-349 (1993)) and rice (Botha, F. C. and Dennis, D. T. Arch Biochem and Biophysics 245: 96-103 (1986)).

Additionally, DNA sequences encoding iPGM have been identified in BLAST searches for Mycoplasma pneumoniae, Helicobacter pylori and Campylobacter jejuni (Galperin, M. Y., Jedrzejas. M. J. Proteins 45:318-24 (2001)), Staphylococcus aureus (van der Oost, J. et al. FEMS Microbiol Lett. 212:111-20 (2002)), Vibrio cholerae (Fraser et al. FEBS Lett. 455:344-348 (1999)) and C. elegans (Galperin et al. Protein Science 7:1829-1835 (1998)) although not all the above exclusively expressed iPGM. Moreover, only a small number of the above-described iPGMs have been cloned (Huang et al. Plant Mol. Biol. 23:1039-1053 (1993)) and overexpressed in E. coli. Active recombinant iPGMs include those from Bacillus stearothermophilus (Chander, M. et al. J Struct Biol. 126:156-65 (1999)), E. coli (Fraser, H. I. et al. FEBS Lett. 455:344-348 (1999)), and Trypanosoma brucei (Chevalier, N. et al. Eur J Biochem. 267:1464-72 (2000)).

Distribution of the two forms of PGM has been reported to be “haphazard” (Fraser, et al. FEBS Lett. 455:344-348 (1999)). The information about iPGM prior to the present analysis was fragmented and suggested that the occurrence of iPGM in various organisms was unpredictable.

Gene knock-out studies reported by Morris, V. L. et al. (J. Bacteriol. 177:1727-33 (1995)) were performed to determine specifically if iPGM is essential for growth or survival in the tomato pathogen Pseudomonas syringae. An insertion of the Tn5 transposon into the iPGM locus of Pseudomonas syringae resulted in a mutant strain that could not grow or infect tomatoes. Leyva-Vazquez et al. (J. Bacteriol. 176:3903-10 (1994)) reported that deletion of the iPGM gene of B. subtilis resulted in slower bacterial growth, less cell density in cultures and an inability to sporulate. Whilst iPGM has been proposed as a potential drug target for certain pathogenic bacteria (Fraser, H. I. et al. FEBS Lett. 455:344-348 (1999), Galperin, M. Y., Jedrzejas, M. J. Proteins 45:318-24 (2001)), trypanosomes (Chevalier, N. et al. Eur J Biochem 267:1464-72 (2000)) and nematodes (Fraser, H. I. et al. FEBS Lett. 455:344-348 1999)), there was no indication in these references that iPGM was required by these organisms for viability, growth or development.

In present embodiments of the invention, the distribution of the two forms of PGM was identified in a variety of organisms (Table 1, FIG. 2). A number of microbial pathogens, fungi, nematodes, protozoa, arthropods and plants were discovered to have the iPGM form exclusively or, in some cases, in conjunction with dPGM. Surprisingly, both parasitic nematodes in general and Wolbachia endosymbionts contain only iPGM. This exclusivity among nematodes is in stark contrast to the apparent haphazard distribution of iPGM in other organisms. The findings presented herein show that iPGM presents a useful drug target for specific organisms in which iPGM is expressed including certain microsporidia, bacteria, protozoa, fungi and ticks. iPGM is a useful drug target for Wolbachia and parasitic nematodes in particular.

iPGM Cloned and Overexpressed in Nematodes

In Example 2, the putative iPGMs from C. elegans, Wolbachia and B. malayi were overexpressed in E. coli and purified. The activities of these recombinant enzymes were confirmed using a standard assay (White, M. F., Fothergill-Gilmore, L. A. Eur J Biochem. 207:709-14 (1992)). Significant PGM activity was measured which did not require 2, 3-diphosphoglycerate, and was insensitive to vanadate, confirming that the enzymes belong to the iPGM class.

The iPGMs cloned in Example 2 resulted from a computational approach described in Example 1 (FIG. 1) which utilized genetic phenotype data obtained from high throughput RNAi by feeding in C. elegans (Fraser, A. G. et al. Nature 408:325-30 (2000)).

In Example 6, a number of phenotypes including embryonic lethality, larval lethality, larval growth defect, body wall morphology defect and uncoordinated movement were found to be associated with knockdown of iPGM by RNAi. The progeny of nematodes injected with RNAi for iPGM were carefully examined over an extended period of time. In the most severe case, RNAi inactivation of iPGM resulted in 100% embryonic lethality. In some plates with lesser embryonic lethality, a percentage of the hatched embryos showed some larval lethality and abnormal body morphology. Surprisingly, these effects were only apparent in embryos laid at least 40 hours post injection. In contrast, such a delayed effect was not observed with other genes. The data described herein confirm convincingly that iPGM is an essential gene in C. elegans. RNAi is one of the inhibitors described herein for iPGM activity and is described in a therapeutic formulation for treating nematode infections or other infections caused by iPGM-containing pathogens.

Screening Assays for Use in Identifying Inhibitors of iPGM

Inhibitors may be identified in any in silico, in vitro or in vivo screening assay that are standard in the art to determine whether a compound can bind to iPGM and/or inhibit the activity of iPGM.

In silico docking programs may be used that incorporate knowledge of enzyme structure and structure activity relationships to identify potential lead compounds. For example, the modeled active sites of cysteine proteases from Leishmania major were used to screen the Available Chemicals Directory (a database of approximately 150,000 commercially-available compounds). Several inhibitors were found (Seizer et al., Exp. Parasitol., 87:212-221 (1997)). Furthermore, knowledge of enzyme structure and structure activity relationships may be used to design potential lead compounds.

In vitro binding assays may be direct binding assays or competitive binding assays. Binding assays may involve phage display techniques, affinity chromatography, immunoassays or other standard techniques. The assays may utilize a solid phase for binding iPGM or a potential inhibitor or substrate where the solid phase is a column, beads or laminar substrate or the assay may be performed in a liquid phase.

Activity assays measure the changes in enzyme activity by measuring changing concentrations of substrate, product or associated factors or by measuring a biological effect on a host. Capillary electrophoresis can be used in a high throughput screening method for an active inhibitor.

Any of the binding and/or activity assays may utilize spectrophotometric, calorimetric, fluorescent, radioactive or chemiluminescent detection methods. For example, a direct scintillation proximity assay may be used to measure inhibition by an increase or decrease of a signal.

In vivo biological assays may be used to measure the effect of an inhibitor on iPGM activity in cells of the pathogen. Another example of a biological assay includes the use of wild type or genetically modified bacterial, fungal, nematode or parasitic strains that may contain a particular iPGM or dPGM.

Inhibitors of iPGM

Individual compounds, classes of compounds, natural extracts, or compound libraries may be screened for iPGM inhibitory activity using screening assays described above. For example, small compound libraries and phage display libraries are available commercially for screening.

A competitive inhibitor may include compounds that are non-hydrolysable analogs of 2-PG or 3-PG, which are substrates for iPGM. These compounds may not inhibit the activity of dPGM since the mechanism of action is completely different and does not require the presence of a cofactor. For example this may include replacement of a phosphate group in the substrate with sulphur.

Other classes of inhibitors act non-reversibly. For example, compounds that bind covalently to iPGM may be non-reversible. Examples of such inhibitors include Di-isopropyl fluorophosphates or sarin, which can covalently bind to an active site serine of enzymes and inactivate the enzymes permanently. Since iPGM possesses an active site serine that is important for catalysis (see FIG. 6), it is possible that a compound belonging to this group that specifically recognizes the serine in the active site of iPGM can inactivate and inhibit iPGM activity.

Examples of inhibitors of iPGM include biological molecules or small organic molecules, more particularly, protein, siRNA, dsRNA, antisense, synthetic molecule, antagonists, small molecule or natural compounds, more particularly, iPGM specific antibodies or their derivatives or antagonists of the iPGM protein including inactive analogs of the iPGM enzyme substrate.

Uses of Inhibitors of iPGM

Inhibition of iPGM results in blocking an essential metabolic enzyme in those pathogens that are characterized by an iPGM. Inhibitors of iPGM such as those described above or identified in screening methods described herein can result in novel treatments for pathogenic infections such as those listed below.

A. Treatment of pathogenic nematode infections in companion animals, specifically cats and dogs, in domestic animals such as horses, cattle and sheep, and in humans.

Parasitic nematodes, including intestinal round worms and heartworm are important parasites of companion animals. For example, Dirofilaria immitis causes heartworm in dogs and cats. Toxocara canis causes intestinal disease in dogs and blindness and visceral larval migrant in humans. Toxascaris leonina causes intestinal disease in dogs and cats. Examples of intestinal round worms that cause severe disease and economic losses in a variety of domestic animal such as horses, cattle and sheep include Haemonchus contortus, Strongyloides spp., Ostertagia spp.

In humans, Brugia malayi and Wuchereria bancrofti cause lymphatic filiariasis leading to elephantiasis, Onchocerca volvulus causes cutaneous filiariasis leading to African river blindness, Trichinella spiralis causes trichinosis, Strongyloides stercoralis cause disseminated strongylidiasis. Necator americanus and Ancylostoma duodenale are hook worms in the human intestine.

B. Treatment of pathogenic nematode infections in plants which result in severe economic losses include Globodera rostochiensis, Meloidogyne incognita, and Heterodera glycines. These nematodes cause root diseases and potato cysts.

C. Treatment of pathogenic microbial infections include treatment of pneumonia caused by Mycoplasma spp, ulcers caused by Helicobacter spp., opportunistic infections in patients with cystic fibrosis, burns or those who are immunocompromised caused by Pseudomonas spp., cholera caused by Vibrio spp., food poisoning caused by Campylobacter jejuni, Q-fever caused by Coxiella burnettii, leptospirosis caused by Leptospira interrogans, and urogenital infections caused by Ureaplasma urealyticum.

D. Treatment of pathogenic fungal infections include treatment of aspergillosis caused by Aspergillus fumigatus, cryptococcosis caused by Cryptococcus neoformans.

E. Treatment of pathogenic protozoan infections with inhibitors of iPGM include Leishmaniasis by Leishmania mexicana, sleeping sickness by Trypanosoma brucci, chagas disease caused by T. cruzi amoebic dysentery by Entamoeba histolytica, and Giardiasis by Giardia lamblia.

Formulations of iPGM Inhibitors for Treating Mammals

The iPGM inhibitors identified herein can be administered to the host in a pharmaceutical formulation and by any delivery route described herein.

The iPGM inhibitor can be formulated using any suitable pharmaceutical diluents that are known to be useful in the art. Such diluents include but are not limited to, saline, buffered saline, dextrose, water, glycerol, ethanol, polyethylene glycol and combinations thereof. The formulation should suit the mode of administration.

The iPGM inhibitor may be administered as a pharmaceutical composition in combination with one or more pharmaceutically acceptable excipients. It will be understood that, when administered to a human patient, the total daily usage of the pharmaceutical compositions of the present invention will be decided by the attending physician within the scope of sound medical judgment. The specific therapeutically effective dose level for any particular patient will depend upon a variety of factors including the type and degree of the response to be achieved; the specific composition, including whether another agent, if any, is employed; the age, body weight, general health, sex and diet of the patient; the time of administration, route of administration, and rate of excretion of the composition; the duration of the treatment; drugs (such as a chemotherapeutic agent) used in combination or coincidental with the specific composition; and like factors well known in the medical arts. Suitable formulations, known in the art, can be found in Remington's Pharmaceutical Sciences, Mack Publishing Company, Easton, Pa. The “effective amount” of the inhibitor for purposes herein is thus determined by such considerations.

The pharmaceutical compositions of the present invention may be administered in a convenient manner such as by the oral, rectal, topical, intravenous, intraperitoneal, intramuscular, intraarticular, subcutaneous, intranasal, inhalation, intraocular or intradermal routes. The term “parenteral” as used herein refers to modes of administration which include intravenous, intramuscular, intraperitoneal, intrasternal, subcutaneous and intraarticular injection and infusion.

The pharmaceutical compositions are administered in an amount, which is effective for treating and/or prophylaxis of the specific indication. In most cases, the iPGM inhibitor dosage is from about 1 mg/kg to about 30 mg/kg body weight daily, taking into account the routes of administration, symptoms, etc. However, the dosage can be as low as 0.001 mg/kg. For example, in the specific case of topical administration dosages are preferably administered from about 0.01 mg to 9 mg per cm.sup.2. In the case of intranasal and intraocular administration, dosages are preferably administered from about 0.001 mg/ml to about 10 mg/ml, and more preferably from about 0.05 mg/ml to about 4 mg/ml.

A course of iPGM inhibitor treatment to treat an infection may vary according to the pathogenic load in the host and the location of the infection.

Generally, the formulations are prepared by contacting the iPGM inhibitor uniformly and intimately with liquid carriers or finely divided solid carriers or both. Then, if necessary, the product is shaped into the desired formulation. The carrier may be a parenteral carrier, more preferably, a solution that is isotonic with the blood of the recipient. Examples of such carrier vehicles include water, saline, Ringer's solution, and dextrose solution. Non-aqueous vehicles such as fixed oils and ethyl oleate are also useful herein, as well as liposomes. Suitable formulations, known in the art, can be found in Remington's Pharmaceutical Sciences, Mack Publishing Company, Easton, Pa.

iPGM inhibitors may also be administered to the eye to treat infections in animals and humans as a liquid, drop, or thickened liquid, or a gel. iPGM inhibitors can also be intranasally administered to the nasal mucosa to treat infections in animals and humans as liquid drops or in a spray form.

The carrier may also contain minor amounts of suitable additives such as substances that enhance isotonicity and chemical stability. Such materials are non-toxic to recipients at the dosages and concentrations employed, and include buffers such as phosphate, citrate, succinate, acetic acid, and other organic acids or their salts; antioxidants such as ascorbic acid; low molecular weight (less than about ten residues) polypeptides, e.g., polyarginine or tripeptides; proteins, such as serum albumin, gelatin, or immunoglobulins; hydrophilic polymers such as polyvinylpyrrolidone; amino acids, such as glycine, glutamic acid, aspartic acid, or arginine; monosaccharides, disaccharides, and other carbohydrates including cellulose or its derivatives, glucose, mannose, or dextrins; chelating agents such as EDTA; sugar alcohols such as mannitol or sorbitol; counterions such as sodium; and/or nonionic surfactants such as polysorbates, poloxamers, or PEG.

iPGM to be used for therapeutic administration may be sterile. Sterility is readily accomplished by filtration through sterile filtration membranes (e.g., 0.2 micron membranes). Therapeutic compositions may be placed into a container having a sterile access port, for example, an intravenous solution bag or vial having a stopper pierceable by a hypodermic injection needle.

iPGM inhibitors may also be suitably administered by sustained-release systems. Suitable examples of sustained-release compositions include semi-permeable polymer matrices in the form of shaped articles, e.g., films, or mirocapsules. Sustained-release matrices include polylactides (U.S. Pat. No. 3,773,919, EP 58,481), copolymers of L-glutamic acid and gamma-ethyl-L-glutamate (Sidman, U. et al., Biopolymers 22:547-556 (1983)), poly (2-hydroxyethyl methacrylate) (Langer, R. et al., J. Biomed. Mater. Res. 15:167-277 (1981), and Langer, R. Chem. Tech. 12:98-105 (1982)), ethylene vinyl acetate (Langer et al., Id.) or poly-D-(−)-3-hydroxybutyric acid (EP 133,988). Sustained-release iPGM inhibitor compositions also include liposomally entrapped iPGM. Liposomes containing iPGM are prepared by methods known per se: DE 3,218,121; Epstein, et al., Proc. Natl. Acad. Sci. USA 82:3688-3692 (1985); Hwang et al., Proc. Natl. Acad. Sci. USA 77:4030-4034 (1980); EP 52,322; EP 36,676; EP 88,046; EP 143,949; EP 142,641; Japanese Pat. Appl. 83-118008; U.S. Pat. Nos. 4,485,045 and 4,544,545; and EP 102,324. Ordinarily, the liposomes are of the small (about 200-800 Angstroms) unilamellar type in which the lipid content is greater than about 30 mol. percent cholesterol, the selected proportion being adjusted for the optimal iPGM inhibitor therapy.

An embodiment of the invention also provides a pharmaceutical pack or kit comprising one or more containers filled with one or more of the ingredients of the pharmaceutical compositions of the invention. Associated with such containers can be a notice in the form prescribed by a governmental agency regulating the manufacture, use or sale of pharmaceuticals or biological products, which notice reflects approval by the agency of manufacture, use or sale for human administration.

All references cited herein are incorporated by reference.

While Examples are provided to illustrate embodiments of the invention, the examples themselves are not intended to be limiting of the scope of the embodiments.

### EXAMPLES

### Example 1

### Computational Method for the Identification of Candidate Drug Targets in Parasitic Nematodes and Wolbachia as Outlined in FIG. 1

Core Concept:

Determine potential drug targets in a pathogen by using phenotypic data from a model organism related to the pathogen in combination with genomic comparisons with the pathogen and its host or a model organism related to the host.

High-Level Flowchart:

1. Genomic screen

Determine whether the protein is in the pathogen or a related model organism.

Yes->(2); No->stop.

2. Phenotypic screen

Determine whether existing phenotypic data suggests that loss or alteration of the protein will be deleterious to the pathogen or a related model organism.

Yes->(3); No->stop.

3. Genomic screen

Determine whether the protein may be common to both pathogen and host or unique to the pathogen.

Unique->(4); Common->stop.

4. Target refinement

Rank potential targets on the basis of a list of desirable properties. Select the top proteins as potential drug targets.

Variations:

1. The two genomic screens could be combined to produce the following equivalent flow path: (1)+(3)->(2)->(4) as step (1) is implied in step (3).

2. Select a set of proteins from the phenotypic screen that have non wild type phenotypes in the pathogen or a related model organism. Then apply the genomic screens to each member of the set to ascertain whether the protein is unique to the pathogen or common to both pathogen and host. Finally, refine the set of unique target proteins. (2)->(3)->(4).

Flowchart for a Given Sequence:

0. A protein sequence.->(1)

1. Is the protein sequence found in the pathogen or a related model organism?

Yes->(2); No->stop.

2. Is the protein sequence referenced in a phenotypic screen?

Yes->(3); No->stop.

3. Does the phenotypic screen indicate a non-wild type phenotype for loss or alteration of this sequence?

Yes->(4); No->stop.

4. Does a host homolog of this sequence exist? Is there a sequence of host origin with a BLAST similarity score whose e-value is less than 1E-10?

Yes->classify as “neither” and stop; No->(5).

5. Does a pathogen homolog of this sequence exist? Is there a sequence of pathogen origin with a BLAST similarity score whose e-value is less than 1E-10?

Yes->classify as class A and go to (6); No->classify as “neither” and stop.

6. Is the protein part of a large gene family in the pathogen?

Yes->place on hold and stop; No->(7).

7. Is the cellular function of the protein known?

Yes->(8); No->place on hold and stop.

8. Is the phenotype associated with loss of the protein considered severely detrimental to the viability of the pathogen?

Yes->(9); No->place on hold and stop.

9. Protein is a promising drug target.

Steps Actually Used:

1. Get list of RNAi target sequences and RNAi phenotypes.

2. Select target sequence from (1) where the RNAi phenotype was not wild type.

3. Get C. elegans peptide sequences from Wormpep database.

4. Select sequences from (3) that were listed in the output from (2).

5. Compare each sequence from (4) [query] against each sequence in the National Center for Biotechnological Information (NCBI) nr protein database [subject] using BLASTP and record results.

6. For each comparison in (5) classify the query as having a mammalian homolog if the e-value score produced by BLASTP in (5) was less than 1E-10 and the subject was annotated as having human or mouse origin.

7. Compare each sequence from (4) [query] against each sequence in the NCBI est others est database [subject] using TBLASTN and record results.

8. For each comparison in (7) classify the query as having a parasitic nematode if the e-value score produced by TBLASTN in (7) was less than 1E-10 and the subject was annotated as having genus Phylum Nematoda as its origin.

9. Classify each target from (4) as either Class A, Class B, or neither based on the output of (6) and (8). If the target did not have a mammalian homolog but had a parasitic nematode homolog, the target is classified as A. If the target had neither a mammalian homolog nor a nematode homolog, it was classified as B. Otherwise the target was classified as neither.

10. Further annotate the list of targets from (9) using data from Wormbase, Gene Ontology database, RNAi database.

11. Evaluate each class A target from (10) to a) confirm gene structure, b) confirm nematode specificity, c) determine if a functional role is known, d) determine the size of the gene family to which the target belongs, and e) note the severity of the RNAi phenotype.

12. Rank the class A targets from (9) using the output of (11).

Candidate drug targets were analyzed further to determine if the putative orthologs of the C. elegans gene are of parasitic nematode or Wolbachia origin. This was done by by searching the complete Wolbachia genomic sequences available from Integrated Genomics, Inc., Chicago, Ill. and New England Biolabs, Inc., Ipswich, Mass.

### Example 2

### Cloning and Sequencing of iPGM from C. elegans, B. malayi. O. volvulus, D. immitis and Various Wolbachia

A number of techniques familiar to the skilled artisan can be used to isolate DNA sequences corresponding to iPGM genes. For example, both genomic DNA and cDNA, or libraries thereof, can be produced from an organism known to possess iPGM sequences from querying available DNA sequences. iPGM sequences can be cloned using PCR or DNA hybridization. Specific or degenerate primers may be designed corresponding to regions of iPGM and used in PCR to isolate the iPGM gene from a variety or organisms. Screening of expression libraries with antibodies generated against iPGM or fragments thereof, may also be used.

C. elegans:

The complete cDNA of C. elegans iPGM (CeiPGM) encoding a putative full length CeiPGM was obtained by PCR amplification using reverse transcribed cDNA with specific primers. These were CeiPGM F (ACGTGGATCCATGTTCGTAGCCCTGGGCGCTC (SEQ ID NO:11) including the predicted translation start together with a BamH I restriction site to facilitate cloning, and CeiPGMR (ACGTAAGCTTCTAGATCTTCTGAACAATCG (SEQ ID NO:12)) containing the predicted stop codon and 3′ end of the gene together with a Hind III site for cloning. The PCR product was digested with BamH I and Hind III and cloned into similarly digested pMAL-c2X cloning vector (New England Biolabs, Inc., Ipswich, Mass.) for production of a maltose binding protein (MBP)-fusion protein. The full length C. elegans iPGM cDNA was sequenced and found to be 1620 bp long. The translated protein was predicted to be 539 amino acids with a molecular weight of 59 kDa and a predicted pI of 5.77. (A second isoform was predicted in C. elegans which lacks an 18 amino acid extension present at the N-terminus of the longer form described above (FIG. 1). This shorter form was amplified from the longer version using specific primers. These were CeiPGM2F (AGTCGGATCCATGGCGATGGCAAATAAC (SEQ ID NO:13)) containing a BamH I site for cloning and CeiPGM2R (AGTCAAGCTTGATCTTCTGAACAATCG (SEQ ID NO:14)) containing a Hind III site. The PCR product was digested with these enzymes and cloned between the BamH I and Hind III sites of pET-21a vector (EMD Biosciences, San Diego, Calif.) for production of a C-terminally His-tagged protein according to the manufacturers instructions. This shorter form C. elegans iPGM cDNA is 1566 bp long and predicts a protein of 521 amino acids with a molecular weight of 57.2 kDa and a pI of 5.58.

B. malayi:

The CeiPGM peptide sequence (gi 17507741) was used to query genomic sequences of B. malayi available at The Institute for Genomic Research (TIGR) and the GenBANK EST database using the program TBLASTN, and two sequences were retrieved from each database. Further analyses revealed that 3 sequences encoded distinct fragments of B. malayi iPGM. The remaining sequence was determined as above to encode a putative, full-length Wolbachia iPGM.

In order to obtain full-length B. malayi iPGM, primers were designed from 2 EST fragments representing the 5′ and 3′ ends of B. malayi iPGM. These were BmiPGMF (ATGCGGATCCATGGCCGAAGCAAAGAATCGAGTATGTCTGGTAGTG ATTGATGGT (SEQ ID NO:15)) beginning with the predicted translation start together with a BamH I site and BmiPGMR (ACTGCTGCAGCTAGGCTTCATTAACC (SEQ ID NO:16)) containing the stop codon, the 3′ end of the gene, and a Pst I site for cloning. BmiPGM was amplified from cDNA from adult females of B. malayi. The PCR product was digested with BamH I and PstI then cloned into pMAL-c2X expression vector that had also been digested with these enzymes. Sequencing revealed that B. malayi iPGM cDNA is 1548 bp long, and encodes a protein of 515 amino acids with a predicted molecular weight of approximately 57 kDa and a predicted pI of 6.65. A second isoform, which is shorter in length, was identified in B. malayi by sequencing additional iPGM clones. This form appears to be missing approximately 24 amino acids and contains a short variant sequence preceding the deleted region. This shorter cDNA isoform is 1476 bp and encodes a protein of 491 amino acids. The predicted molecular weight and pI are 55 kD and 7.9, respectively.

Both isoforms of BmiPGM were also cloned into the pET-21a His tag expression vector. BmiPGM2F (AGTCGGATCCATGGCCGAAGCAAAGAATCG (SEQ ID NO:17)) corresponding to the translation start and containing a BamH I site and BmiPGM2R (ATGCCTCGAGGGCTTCATTAACCAATGGC (SEQ ID NO:18)) corresponding to the 3′ end of BmiPGM cDNA together with a Xho I site were used to amplify from the iPGM forms cloned in pMAI-c2X. The PCR products were digested at the restriction sites included in the primer sequences then cloned into similarly digested pET-21a vector to allow expression of C-terminally His-tagged iPGM isoforms.

O. volvulus:

The CeiPGM peptide sequence (gi 17507741) was used to query the GenBank EST database using the program TBLASTN, and 2 sequences (gi 7138173, gi 2541844) were retrieved. Further analyses revealed these sequences encoded the 5′ and 3′ ends of O. volvulus iPGM. cDNA clones encoding these ESTs were obtained and used to amplify the full length the full length O. volvulus cDNA. The primers used were OviPGMF (ATGAGCGAAGTGAAAAATCGGGT (SEQ ID NO:19)) beginning with the predicted translation start and OviPGMR (CTAGACTTCAATAACCACTGG (SEQ ID NO:20)) containing the stop codon.

Wolbachia from B. malayi:

A candidate full-length iPGM from Wolbachia endosymbionts of B. malayi was identified amongst the genomic sequences derived from B. malayi as described above. This iPGM was initially cloned into pMAL-c2X following amplification from a Wolbachia BAC clone containing the appropriate sequence using primers WoliPGMF (ATGAACTTTAAGTCAGTTGTTTTATGTATAC (SEQ ID NO:21)) corresponding to the translation start and WoliPGMR (TACAAGCTTTTACAATCAGTGAACTACCTGTC (SEQ ID NO:22)) containing the 3′ end of the iPGM sequence together with the stop codon and a Hind III site. The blunt-ended PCR product generated by Vent® polymerase (New England Biolabs, Inc., Ipswich, Mass.) was digested with Hind III and cloned into pMAL-c2x expression vector that had been digested with XmnI and HindIII. WoliPGM is 1563 bp long, and encodes a protein of 501 amino acids with a predicted molecular weight of approximately 56 kDa and a predicted pI of 6.39. The WoliPGM was also cloned into the pET-21a His-tag vector. For this, WoliPGM2F (AGTCGGATCCATGAACTTTAAGTCAGTTG (SEQ ID NO:23)) corresponding to the translation start together with a BamH I site, and WoliPGM2R (ATGCAAGCTTCACAATCAGTGAACTACCTGTC (SEQ ID NO: 24)) corresponding to the 3′ end of the gene together with a Hind III site were used to amplify iPGM from the pMAL construct described above. The PCR product was digested with BamH I and Hind III and cloned between the same sites of the pET-21a vector.

These cloned and sequenced iPGMs are also highly homologous to known iPGMs from a number of diverse organisms when compared by amino acid alignment. As shown in FIG. 6, they are all of a similar size and appear to possess the catalytic serine and other active site residues defined by the crystal structure of an iPGM from B. stearothermophilus (Jedrzejas et al. EMBO J. 19:1419-1431 (2000)).

Among these iPGMs, the amino acid identity along the entire protein, ranges from 26% (C. elegans vs. T. brucei) to 77% (B. anthrax vs. B. subtilis). Intermediate levels of relatedness were found when other organisms were compared: C. elegans vs. E. coli (43%), E. coli vs. B. anthrax (48%), E. coli vs. M. pneumoniae (42%), C. elegans and B. malayi (71%). Wolbachia iPGM (WoliPGM) is most closely related to the iPGM from Clostridium perfringens (46%), and possesses 40% and 41% identity to the iPGMs from B. malayi and C. elegans, respectively. The relatively high degree of conservation found among these molecules, and particularly in their active site residues, implies a common enzyme mechanism. From the degree of conservation noted above, a single inhibitor against one particular iPGM will be an inhibitor of iPGMs derived from other diverse species.

The above approach is used to clone and sequence iPGMs from D. immitis, and the Wolbachia endosymbionts from O. volvulus and D. immitis as well as iPGMs from other organisms. Production and purification of recombiant iPGM is described in Example 4.

### Example 3

### Survey of the Distribution of iPGMs and dPGMs

With a view to considering iPGM as drug target in other infectious organisms, a systematic bioinformatic analysis was performed to determine the phylogenetic distribution of the two forms of PGM. CeiPGM and human dPGM protein sequences were used to query the genomes of pathogens and other organisms in the GenBank database. Table 1 summarizes the data obtained from selected completed genome sequences. Some organisms possess either iPGM or dPGM, while others have both forms. From this analysis, it is apparent that the presence of iPGM and/or dPGM in any given organism cannot be predicted based on its phylogenetic classification. For example, among the proteobacteria, which has the largest representation in this study including members of different subdivisions, all possibilities were found. Namely, some species have only iPGM (Wolbachia, Agrobacterium tumefaciens), or dPGM (Brucella melitensis) and some have both forms (E. coli).

In the iPGM containing pathogens included in Table 1, iPGM represents an excellent drug target. This includes Clostridium perfringens, Mycoplasma spp., Agrobacterium tumefaciens, Pseudomonas spp., Vibrio spp., Campylobacter jejuni, Helicobacter spp., Giardia lamblia and Encephalitozoon cuniculi, Leptospira interrogans, Coxiella burnetii, Ureaplasma urealyticum, Cryptococcus neoformans, Aspergillus oryzae, Leishmania mexicana and Trypanosoma spp. Since it is not known if dPGM can compensate for any iPGM deficiency, iPGM still represents a valid drug target in those organisms, which have both forms listed in Table 1, namely Bacillus anthracis, Staphylococcus spp, Listeria spp, Shigella flexneri, Salmonella spp., Clostridium acetobutylicum and Yersinia pestis

TABLE 1
Distribution of iPGM and dPGM in selected organisms with completed genomes.
C. elegans iPGM (gi 17507741, 539aa) or human dPGM (gi 130353, 253 aa) were used as
the query sequences to perform BLASTP search for homologs in the Genbank. BLASTP scores
higher than 60 are listed and used as the cutoff value for the presence of a homologous
protein. ˜indicated genome sequence obtained from New England Biolabs, Ipswich, MA.

| Taxonomic Group | Species | iPGM | dPGM | Known infections |
|---|---|---|---|---|
| Firmicutes/Bacilli | Bacillus subtilis | + | − | |
| Firmicutes/Bacilli | Bacillus anthracis | + | + | Anthrax |
| Firmicutes/Bacilli | Staphylococcus aureus | + | + | Impetigo |
| Firmicutes/Bacilli | Listeria monocytogenes | + | + | Listeriosis |
| Firmicutes/Clostridia | Clostridium perfringens | + | − | Botulism |
| Firmicutes/Clostridia | Clostridium acetobutylicum | + | + | |
| Firmicutes/Mollicutes | Mycoplasma pneumoniae | + | − | Pneumonia |
| Firmicutes/Mollicutes | Ureaplasma urealyticum | + | − | Uro-genital infection |
| Proteobacteria/Alpha | Wolbachia (Brugia) | + | −˜ | |
| Proteobacteria/Alpha | Agrobacterium tumefaciens | + | − | Plant tumor |
| Proteobacteria/Alpha | Brucella melitensis | − | + | Brucellosis |
| Proteobacteria/Beta | Neisseria meningitidis | − | + | Meningitis |
| Proteobacteria/Gamma | Pseudomonas syringae | + | − | Plant pathogen |
| Proteobacteria/Gamma | Pseudomonas aeruginosa | + | − | Opportunist |
| Proteobacteria/Gamma | Vibrio cholerae | + | − | Cholera |
| Proteobacteria/Gamma | Escherichia coli | + | + | |
| Proteobacteria/Gamma | Shigella flexneri | + | + | Shigellosis |
| Proteobacteria/Gamma | Salmonella typhimurium | + | + | Salmonellosis |
| Proteobacteria/Gamma | Yersinia pestis | + | + | Plague |
| Proteobacteria/Gamma | Coxiella burnetii | + | − | Q fever |
| Proteobacteria/Epsilon | Campylobacter jejuni | + | − | Campylobacter |
| Proteobacteria/Epsilon | Helicobacter pylori | + | − | Ulcer |
| Actinobacteria/Actinobacteria | Mycobacteria tuberculosis | − | + | TB |
| Actinobacteria/Actinobacteria | Chlamydophia pneumoniae | − | + | Pneumonia |
| Actinobacteria/Actinobacteria | Streptomyces avermitilis | − | + | |
| Actinobacteria/Actinobacteria | Streptomyces coelicolor | + | + | |
| Spirochaetes/Spirochaetes | Leptospira interrogans | + | − | Leptospirosis |
| Fungi/Basidiomycota | Cryptococcus neoformans | + | − | Cryptococcosis |
| Fungi/Ascomycota | Aspergillus oryzae | + | − | Aspergillosis |
| Fungi/Microsporidia | Encephalitozoon cuniculi | + | − | HIV opportunist |
| Fungi/Ascomycota | Saccharomyces cerevisiae | − | + | |
| Fungi/Ascomycota | Schizosaccharomyces pombe | − | + | |
| Hexamitidae | Giardia lamblia | + | − | Giardiasis |
| Apicomplexa | Cryptosporidium parvum | − | + | Cryptosporidiosis |
| Apicomplexa | Plasmodium falciparum | − | + | Malaria |
| Kinetoplastids | Trypanosoma brucei | + | − | Sleeping sickness |
| Entamoebidae | Entamoeba histolytica | + | − | |
| Nematoda | Brugia malayi | + | − | Filariasis |
| Nematoda | Caenorhabditis elegans | + | − | |
| Vertebrate | Homo sapiens | − | + | |
| Arthropoda | Anopheles gambiae | − | + | |
| Arthropoda | Drosophila melanogaster | − | + | |
| Plant | Arabidopsis thaliana | + | + | |

The genome database for many parasites predominantly contains only EST sequencing projects. To strengthen the case for selecting iPGM as a candidate drug target against nematodes directly or, in the case of filarial nematodes, potentially against their Wolbachia endosymbionts over 400,000 available nematode EST sequences and the Wolbachia genome were queried with both the C. elegans iPGM (gi 17507741) and with human dPGM (gi 130353) peptide sequences. Thirty-eight non-C. elegans nematode iPGM fragments were identified with high probability scores (<p=10⁻¹⁰) using the C. elegans iPGM peptide to query the GenBank EST database. These nematode iPGM gene fragments grouped into 14 clusters representing iPGM from 12 parasitic nematode species (FIGS. 5A and 5B). In a similar search no matches were found for the human dPGM query. Therefore, iPGM represents a broad spectrum target for nematodes that include in addition to B. malayi, at least the following parasites of human: Onchocerca volvulus, Strongyloides stercoralis; Trichinella spiralis, Necator americanus; animal: Litomosoides sigmodontis, Ostertagia ostertagia, Haemonchus contortus, Trichuris muris and plant: Globodera rostochiensis, Meloidogyne incognita and Heterodera glycines. Similarly, iPGM was identified in the Wolbachia endosymbiont while a dPGM ortholog was not detected (Table 1). Therefore, iPGM is particularly suited as a candidate drug target in Wolbachia. For those ESTs that span the region containing the catalytic serine, the catalytic serine and several adjacent amino acid residues are identical, indicating that they function similarly.

The various iPGM molecules identified above were analyzed further to determine their relatedness. iPGMs from 24 species were compared using sequence alignment and phylogenetic analysis (FIGS. 6 and 7). Enzymes from related species were found to cluster in the same branch on a phylogenetic tree and possessed higher degrees of identity.

### Example 4

### Production and Purification of Recombinant iPGM Enzyme from C. elegans, B. malayi and Wolbachia

A number of techniques familiar to the skilled artisan can be used to produce and purify recombinant iPGM from any source. For example, a fusion protein comprising an iPGM and a protein or tag having binding affinity for a substrate, e.g., amylose or nickel, is used in affinity chromatography to purify the fusion protein. Techniques for producing fusion proteins are well known to the skilled artisan. See Sambrook, J. et al., Molecular Cloning: A Laboratory Manual, Cold Spring Harbor Laboratory Press, Cold Spring Harbor, N.Y., pp. 17.29-17.33 (1989). For convenience, commercially available systems may be used, including for example, the Protein Fusion and Purification System from New England Biolabs, Inc., Ipswich, Mass.; U.S. Pat. No. 5,643,758), or the His-tag expression system from several sources.

The full-length iPGMs from C. elegans, B. malayi and Wolbachia were overexpressed in E. coli as fusion proteins with MBP, using the pMAL-c2X vector (New England Biolabs, Inc., Ipswich, Mass.), or with His-tags using the pET21 vector (EMD Biosciences, San Diego, Calif.). The cDNAs described in Example 1 were cloned into the respective vectors following manufacturers instructions. Both C. elegans and B. malayi iPGM in pET21a(+) were expressed in the E. coli strain ER2566 (fhuA2 lacZ::T7 gene1 [Ion] ompT gal sulA11 [dcm] R (zgb-210::Tn10—TetS) endA1 D(mcrC-mrr)114::IS10 R(mcr-73::miniTn10—TetS)2) (New England BioLabs, Inc., Ipswich, Mass.). Conditions were optimized to maximize expression, solubility and yield of each recombinant protein. For CeiPGM, cultures were grown at 30° C. and induced with 0.1 mM isopropylthio-β-D-galactoside (IPTG), Sigma-Aldrich, St. Louis, Mo.) at 15° C. overnight. BmiPGM was produced by growing cultures at 37° C. and inducing with 0.1 mM IPTG for 3 hours at 37° C. The His-tagged proteins were extracted, and purified on nickel columns (Qiagen, Inc., Valenicia, Calif.) using native conditions according to the manufacturer's instructions. An elution buffer (40 mM NaH₂PO₄, 300 mM NaCl, pH 8.0) containing 60 mM Imidazole was found to be optimal in releasing both His-tagged proteins from the nickel resin with a high level of purity. For generation of Wolbachia iPGM-MBP fusion protein, cultures were grown at 37° C. for 3 hours with 0.3 mM IPTG.

FIG. 8 shows representative overexpression and purification of an iPGM from B. malayi using the His-Tag system. BmiPGM was expressed at a high level after induction in E. coli (lane 2). The protein was highly soluble and purified to homogeneity using nickel chelate chromatography (lanes 6-11). iPGM from C. elegans was generated in a similar manner. For WoliPGM, the MBP system was more efficient for obtaining soluble protein.

The above approach is used to produce and purify iPGMs from D. immitis, O. volvulus, their Wolbachia endosymbionts and iPGMs from other organisms.

### Example 5

### Measurement of iPGM Activity

The purified CeiPGM, WoliPGM and BmiPGM proteins described in Example 4 were assayed for PGM activity and found to be active. Activity was measured in forward and reverse directions using a standard spectrophotometric assay (White and Fothergill-Gilmore, European J. Biochem. 207:709-714 1992)) as outlined in FIG. 9. In the forward reaction (glycolytic), the conversion of 3-PG to 2-PG is measured, whereas in the reverse direction (gluconeogenic), the conversion of 2-PG to 3-PG is assayed. In both cases, PGM activity was determined indirectly by measuring the consumption of NADH, which is monitored at 340 nm. The amount of NADH being oxidized to NAD corresponds to the amount of enzyme product (2-PG in the forward direction or 3-PG in the reverse direction) yielded in the PGM reaction. Reactions were performed at 30° C. for 5 minutes with data collected at 10-second intervals using a Beckman DU 640 spectrophotometer. In the forward reaction, iPGM was added to 1 ml assay buffer (30 mM Tris-HCl pH 7.0, 5 mM MgSO₄, 20 mM KCl, 0.15 mM NADH) containing 1 mM ADP, 10 mM 3-PGA (Sigma P8877, Sigma-Aldrich, St. Louis, Mo.), 2.5 U each of enolase (Sigma E6126, EC 4.2.1.11, Sigma-Aldrich, St. Louis, Mo.), pyruvate kinase (Sigma P7768, EC 2.7.1.40, Sigma-Aldrich, St. Louis, Mo.) and lactate dehydrogenase (Sigma L2518; EC 1.1.1.27, Sigma-Aldrich, St. Louis, Mo.). In the reverse reaction, iPGM was added to 1 ml assay buffer containing 1 mM ATP, 10 mM 2-PG (Sigma P0257, Sigma-Aldrich, St. Louis, Mo.), 2.5 units each of phosphoglycerate kinase (Sigma P7634; EC 2.7.2.3, Sigma-Aldrich, St. Louis, Mo.) and glyceraldehyde 3-phosphate dehydrogenase (Sigma G0763; EC 1.2.1.12, Sigma-Aldrich, St. Louis, Mo.). One unit of PGM activity is defined as the amount of activity that is required for the conversion of 1.0 μM NADH to NAD per minute in the above assay conditions.

The measured PGM activity with recombinant iPGMs showed typical enzyme kinetics (FIG. 10). The activities were concentration dependent, active with Mg⁺⁺, and active over a range of pH values. The activities were not dependent on 2, 3-diphosphoglycerate and were not inhibited by vanadate, confirming that the enzymes belong to the iPGM group. The following specific activities were obtained for B. malayi: 93 units/mg (forward) and 88 units/mg (reverse) and C. elegans 40 units/mg (forward) and 86 units/mg (reverse), respectively.

### Example 6

### Effect of RNAi Inactivation of iPGM in C. elegans

A number of techniques familiar to the skilled artisan can be used to produce dsRNA and perform RNAi in C. elegans including soaking, injection and transformation methods (Fire et al. Nature 391, 806-811 (1998)). For other organisms, short interfering RNA (siRNA) corresponding to a region of the iPGM gene may be generated using standard methods.

To examine further the requirement of iPGM for the successful development of C. elegans, iPGM was knocked down by RNAi using the injection method. dsRNA (1 kb long), corresponding to a part of the CeiPGM cDNA, was prepared using the HiScribe Kit (New England Biolabs, Inc., Ipswich, Mass.) according to manufacturer's instructions. C. elegans young adults (wild type N2) were injected with 1 mg/ml or 3 mg/ml RNA into the germ line and allowed to recover on NGM plates overnight before singled out on fresh NGM plates. Thereafter, each injected worm was transferred to a fresh NGM plate every 8 or 16 hours. The embryos were counted immediately after transfer and the L1 larvae counted approximately 24 hrs later. The progeny were counted again when the progeny from control uninjected worms reached young adults.

TABLE 2
The effect of RNAi inactivation of iPGM on egg hatching in C. elegans

| | | 18-26 hrs | | 26-42 hrs | | 42-50 hrs | | 50-66 hrs | |
|---|---|---|---|---|---|---|---|---|---|
| Experiments | | % | # | % | # | % | # | % | # |
| No injection | Worm 1 | 1.9 | 52 | 0.0 | 93 | 8.7 | 23 | 0.0 | 7 |
| | Worm 2 | 1.6 | 61 | 0.0 | 97 | 0.0 | 46 | 0.0 | 71 |
| | Worm 3 | 1.7 | 59 | 2.0 | 101 | 5.3 | 19 | 0.0 | 4 |
| | Total | 1.7 | 172 | 0.0 | 291 | 3.4 | 88 | 0.0 | 82 |
| 1 mg/ml dsRNA | Worm 1 | 0.0 | 45 | 31.9 | 116 | 97.1 | 35 | 100.0 | 7 |
| | Worm 2 | 0.0 | 36 | 4.4 | 68 | 96.2 | 26 | 100.0 | 9 |
| | Worm 3 | 0.0 | 34 | 18.6 | 70 | 100.0 | 13 | 50.0 | 2 |
| | Total | 0.0 | 115 | 20.9 | 254 | 97.3 | 74 | 94.4 | 18 |
| 3 mg/ml dsRNA | Worm 1 | 4.0 | 50 | 27.3 | 88 | 100.0 | 31 | 100.0 | 13 |
| | Worm 2 | 0.0 | 38 | 8.0 | 88 | 90.5 | 21 | 81.8 | 11 |
| | Worm 3 | 20.0 | 15 | 0.0 | 48 | 38.3 | 47 | 83.3 | 102 |
| | Total | 3.9 | 103 | 13.8 | 224 | 68.7 | 99 | 84.9 | 126 |

% - Percentage of embryos failed to hatch
# - Number of embryos laid by single worm during that time period

As shown in Table 2 and FIG. 11, in the most severe case, RNAi inactivation of iPGM resulted in 100% of eggs laid failing to develop. In some plates with lesser embryonic lethality, a percentage of the hatched embryos showed some larval lethality (19% larval lethal of hatched worms [total 31 worms] scored at 42-50 hrs and 37% larval lethal of hatched worms [total 19 worms] at 50-65 hrs, both injected with 3 mg/ml dsRNA) and abnormal body morphology (FIG. 12). These effects were only observed in embryos laid longer than 42 hours after injection (FIG. 11A). This is suggestive of a delayed RNAi phenotype since RNAi inactivation of control genes namely unc-22 (uncoordinated phenotype) and T13F2.7 (embryonic lethal phenotype) were observed with full penetrance in progeny laid as early as 18 hours post injection (FIG. 11B).

The detrimental effects resulting from RNAi may be reproduced using an inhibitor of iPGM enzyme activity and provide a means of treating pathogen infections.

The above approach is used to perform RNAi in nematodes and other gene silencing strategies may be used to reduce iPGM gene activity in other organisms. Gene silencing techniques have the feature that they selectively inhibit iPGM and not dPGM gene function.

### Example 7

### Inhibitors of Phosphotransferase or Phosphatase Enzymes Inhibit iPGM Activity

PGM activity involves both a phosphotransferase and phosphatase activity. iPGM belongs to the alkaline phosphatase superfamily. Therefore inhibitors of phosphatase or transferase activity may have inhibitory effects on iPGM activity. Examples of alkaline phosphatase inhibitors include: levamisole and 2-hydroxy-4-phosphonobutanoate, which is a phosphomethyl analog of 3-PG.

### Example 8

### Reversible and Irreversible Inhibitors of iPGM Activity

Based on the structural differences which exist between iPGM and dPGM enzymes and the fact that they utilize different enzymatic mechanisms, selective inhibitors will inhibit the enzyme activity of iPGM and not interfere with dPGM activity. This includes compounds that bind to the substrate binding site, the phosphotransferase or phosphatase sites, or to the enzyme substrate intermediate.

Examples of reversible inhibitors include: 3-sulphoglycerate.

Examples of irreversible inhibitors include compounds that bind covalently to iPGM either at the active site or other sites. It is well known that a group of reactive compounds (such as Diisopropyl fluorophosphates or sarin) can covalently bind to active site serine of enzymes and inactivate the enzymes permanently. Since iPGM possessrd an active site serine that is important for catalysis, it is possible that a compound belonging to this group that specifically recognizes the serine in the active site of iPGM will potently inactivate and therefore inhibit iPGM activity.

### Example 9

### Phosphoglycerate Analog for Inhibiting Activity of iPGM

An inhibitor of iPGM activity may include a compound that mimics non-hydrolysable analogs of 2-PG or 3-PG, which are substrates for iPGM. Examples may include thiophosphate analogs of 2-PG or 3-PG, which may bind to the enzyme but cannot be cleaved. Another example is a phosphate thioester analog of 2-PG or 3-PG. A further example is a molecule in which a selenate replaces a phosphate group which can act as a substrate analog for iPGM.

### Example 10

### Specific Antibody for Inhibiting the Activity of iPGM

Polyclonal and monoclonal antibodies specific for iPGM, in particular, those directed against the substrate binding site may inhibit the activity of iPGM. Antibodies may be generated by a number of techniques familiar to persons skilled in the art using the entire molecule, parts thereof, or peptides

### Example 11

### Computational Method for the Identification of Candidate Drug Targets in Brugia malayi

This Example describes a computational method for the identification of candidate drug targets in the parasitic nematode Brugia malayi as outlined in FIG. 1. It uses a variation of the approach described in Example 1, termed variation 2 within Example 1.

Core Concept:

Enumerate a list of potential drug targets in a pathogen (Brugia malayi) by using phenotypic data from a model organism related to the pathogen (Cenorhabiditis elegans) in combination with genomic comparisons with the pathogen and its host.

High-Level Flowchart:

1. Phenotypic screen

Determine whether existing phenotypic data in the model organism Cenorhabditis elegans suggests that loss or alteration of the protein will be deleterious to the model organism.

Yes->(2); No->stop.

2. Genomic screen

Determine whether the protein from (1) may be common to both pathogen and host or unique to the pathogen.

Unique->(3); Common->stop.

3. Target List

Annotate the targets produced from (2) using available data resources.

Steps Used:

1. Get a list of accession numbers for RNAi target sequences in C. elegans and their corresponding RNAi phenotypes from databases at wormbase.org.

2. Select target sequences from (1) where the RNAi phenotype was not wild type.

3. Get C. elegans peptide sequences corresponding to the accession numbers collected in step 2 from the Wormpep database.

4. Compare each sequence from (3) [query] against each sequence in the National Center for Biotechnological Information (NCBI) nr protein database [subject] using BLASTP and record results.

5. For each comparison in (4) classify the query as having a mammalian homolog if the e-value score produced by BLASTP in (4) was less than 1×10-8 and the subject was annotated as having mammalian origin.

6. Compare each sequence from (4) [query] against each sequence in a database of predicted coding sequences derived from the complete genomic sequence of Brugia malayi using BLASTP and record results.

7. For each comparison in (6) classify the query as having a homolog in Brugia malayi if the e-value score produced by BLASTP in (6) was less than 1×10-20.

8. If the target did not have a mammalian homolog but had a Brugia malayi homolog, the target was classified as a potential drug target.

9. Annotate the list of potential drug targets from (8) using data from Wormbase, Gene Ontology database, RNAi database and the Brugia malayi genomic sequence database. The results of a search such as described above are provided in FIG. 14-1 to 14-9. The potential drug targets are identified by a TIGR model number in a public database, each model number corresponding to a gene, the sequence of each gene being incorporated by reference.

What is claimed is:

1. A computational method for identifying one or more proteins in a pathogen, suitable as a target in a screening assay to detect a therapeutic agent, comprising:
(a) determining computationally from a genome wide RNA gene silencing database whether loss or alteration of one or more proteins results in a phenotypic change detrimental to a pathogen;
(b) determining computationally whether the one or more proteins occur exclusively in the pathogen and not in its host;
(c) identifying a ranking order for the one or more protein identified in (a) and (b); and
(d) determining from the ranking order, whether the one or more proteins are suitable as a target in a screening assay to detect a therapeutic agent.

2. A computational method according to claim 1, wherein pathogen is selected from a parasitic nematode, a fungus, a microbial pathogen and a protozoan pathogen.

3. A computational method according to claim 1, wherein the ranking order is determined by at least one characteristic additional to (a) and (b) selected from the group consisting of: (i) occurrence of the protein among pathogens, (ii) relative homology among the amino acid sequences or DNA sequences of the protein isolated from different sources, (iii) physical properties of the protein for identifying therapeutic modulators, and (iv) an assay for measuring the functional activity of the protein.

4. A polynucleotide, comprising: a nucleotide sequence capable of hybridizing under stringent conditions to SEQ ID No:1, wherein the polynucleotide encodes a protein having independent phosphoglycerate mutase (iPGM) activity and expressed in a nematode other than Caenorhabditis elegans (C. elegans).

5. A polynucleotide sequence according to claim 4, wherein the nucleotide sequence is selected from SEQ ID NOS:3, 4 and 5.

6. A polynucleotide, comprising: SEQ ID NO:2.

7. A polynucleotide, comprising: a sequence that is at least 60% identical to SEQ ID. NO:1, the polynucleotide encoding an iPGM expressed in a nematode other than C. elegans.

8. A recombinant nematode iPGM comprising at least 70% amino acid identity with SEQ ID NO:6.

9. A recombinant nematode iPGM according to claim 8, comprising an amino acid sequence selected from SEQ ID NOS:7, 8, 9 and 10.

10. A method for identifying an inhibitor of viability of a pathogen wherein the pathogen is characterized by the presence of iPGM, comprising;
(a) selecting one or more candidate inhibitor molecules for screening for inhibitory activity of iPGM;
(b) performing a functional assay to determine which if any of the candidate molecules are capable of inhibitory activity; and
(c) identifying from step (b) which candidate molecules have iPGM inhibitory activity capable of inhibiting viability of the pathogen.

11. A method according to claim 10, wherein the pathogen is a microbial pathogen.

12. A method according to claim 10, wherein the pathogen is a nematode.

13. A method according to claim 10, wherein the pathogen is a microsporidia.

14. A method according to claim 10, wherein the pathogen is a fungus.

15. A method according to claim 10, wherein the pathogen is a protozoan.

16. A method according to claim 11, wherein the microbial pathogen is selected from the group consisting of: Vibrio cholera, Pseudomonas aeruginosa, Campylobacter jejuni, Helicobacter pylori, Clostridium perfringens, Mycoplasma pneumoniae, Campylobacter jejuni, Coxiella burnettii, Leptospira interrogans, Agrobacterium tunefaciens, Uearplasma urealyticum, and Wolbachia.

17. A method according to claim 15, wherein the protozoan pathogen is Giardia lamblia.

18. A method according to claim 12, wherein the pathogenic nematode is selected from Onchocerca volvulus, Brugia malayi, Dirofilaria immitis, Strongyloides stercoralis, Necator americanus, Trichuris muris, Trichinella spiralis, Litomosoides sigmodontis, Ostertagia ostertagi, Haemonchus contortus, Globodera rostochiensis, Meloidogyne incognita, Toxocara cani, Toxascaris leonina, Wuchereria bancrofti, Ancylostoma duodenale, Ascaris lumbricoides, Ascaris suum and Heterodera glycines.

19. A method according to claim 13, wherein the microsporidium is Encephalitozoon cuniculi.

20. A method according to claim 14, wherein the fungal pathogen is selected from Aspergillus fumigatus and Cryptococcus neoformans.

21. A method according to claim 10, wherein the functional assay is biochemical assay that measures the interconversion of 3-phosphoglycerate (3-PG) and 2-phosphoglycerate (2-PG).

22. A method according to claim 10, wherein the functional assay is a biological assay, which measures the viability of the pathogen after treatment with the candidate inhibitor.

23. A method according to claim 22, wherein the pathogen is a nematode pathogen and measuring viability is determined by assaying inhibition of egg maturation, larval lethality, or growth inhibition.

24. A method according to claim 10, wherein the inhibitor is a dsRNA capable of gene silencing.

25. A method according to claim 10, wherein the inhibitor is an antibodies or fragment thereof.

26. A method according to claim 10, wherein the inhibitor is a small molecule.

27. A method according to claim 10, herein the inhibitor is a natural extract.

28. A method for treating a pathogenic infection in a host, wherein the pathogen utilizes an iPGM for interconversion of 3-PG and 2-PG, comprising:
obtaining an iPGM inhibitor in a physiological formulation; and
administering a therapeutically effective amount of iPGM inhibitor to the host for treating the pathogenic infection.

29. A method according to claim 28, wherein the host is a mammal.

30. A method according to claim 29, wherein the mammal is a companion mammal or a domestic mammal.

31. A method according to claim 29, wherein the mammal is a human.

32. A method according to claim 28, wherein the host is a plant.

33. A method according to claim 28, wherein the inhibitor is a double stranded RNA molecule of a size and sequence suitable for silencing an iPGM gene.

34. A method according to claim 28, wherein the inhibitor is an anti-iPGM antibody or fragment thereof suitable for inhibiting iPGM activity.

35. A method according to claim 28, wherein the inhibitor is a non-hydrolyzable substrate analog or derivative thereof.

36. A method according to claim 35, wherein the inhibitor is an alkaline phosphatase inhibitor or derivative thereof.

37. A method according to claim 36, herein the inhibitor is levamisole or hydroxy-4-phosphonobutanoate or derivative thereof.

38. A method according to claim 28, wherein the inhibitor is a thiophosphate, thioester or seleno analog of 2-PG or 3-PG.


SEQUENCE LISTING (49 sequences)

SEQ ID NO: 1 - DNA, 57 bp, unknown
  iPGM conserved sequence
atgggcaattcagaagtgggtcatttaaacattggcgctggccgtgttgtttatcag

SEQ ID NO: 2 - DNA, 1566 bp, Caenorhabditis elegans
atggcgatggcaaataacagttcggtggccaataaggtctgtctcatcgttattgatggatggggagtttctgaagatccttacggtaacgctattctcaacgcacagacaccagttatggacaagctgtgttcgggcaattgggctcaaattgaggcacatggtcttcatgttggtctcccagaaggattgatgggaaattcggaagtcggacatttgaacatcggagccggacgtgttatctatcaagacattgttcgtattaatctggcagtcaagaacaacaaatttgtgactaatgagagcttggtggatgcttgcgatcgtgctaaaaacggaaatggacgtcttcatctggccggacttgtttctgacggaggtgttcattctcatattgatcacatgtttgctttggttaaggccatcaaagagctcggagttccagaactttaccttcatttctacggagatggtcgtgatacttctccaaacagtggagttggattccttgaacaaaccctcgagttcttggagaaaactactggatatggaaaactagctactgtagttggccgctactatgctatggatcgcgataacagatgggagcgtatcaatgttgcatacgaggcaatgattggaggtgttggagagacttccgatgaggctggggttgttgaagttgttcgcaagcgttacgctgctgatgaaacagacgaattcttgaagccaatcattcttcaaggagagaaaggacgtgttcaaaatgacgatacaatcatcttcttcgactaccgtgctgatcgtatgcgtgagatttctgcagcaatgggaatggatcgttacaaggattgcaattcgaagttagctcatccatcaaatcttcaagtatatggaatgactcaatacaaagccgagttcccattcaaatcgctgttcccgccagcatcgaacaaaaatgtattggctgagtggctcgccgagcaaaaagtttcgcaatttcattgtgcggaaaccgaaaaatacgctcacgttacatttttcttcaatggaggacttgaaaaacaatttgagggagaagaaaggtgtttagtgcccagtccaaaggtcgcaacttacgatcttcaaccagaaatgtctgcggccggcgttgctgacaaaatgattgaacaactcgaggctggaactcatccattcattatgtgcaactttgctccaccagatatggtcgggcatacgggagtctatgaagctgctgtcaaggcctgtgaagctactgatatcgcaatcggaagaatctatgaagcaactcaaaagcacggatactcacttatggttactgctgatcacggaaatgctgaaaagatgaaggctccagatggtggaaaacacactgctcacacatgttaccgtgttccactcactttgagccatccaggattcaaatttgtcgatccagccgaccgtcatccggccctttgtgatgttgctccaacagttctcgctattatgggactccctcaaccagctgaaatgactggggtctcgattgttcagaagatctag

SEQ ID NO: 3 - DNA, 1548 bp, Brugia malayi
atggccgaagcaaagaatcgagtatgtctggtagtgattgatggttggggaatcagtaacgaaactaaaggcaatgcaatactaaatgctaaaacacctgtaatggatgagctttgtgtaatgaattcgcatccaattcaagcacatggcttgcatgttggtttaccggaaggacttatgggcaattcagaagtgggtcatttaaacattggcgctggccgtgttgtttatcaggatattgtacgcataaatttggcggtcaagaataagactttggtggaaaataagcatttgaaggaagctgctgaacgtgcaattaaagggaatggccgcatgcacttatgtggtttggtcagcgatggtggtgtgcattcacatattgatcatttgtttgctttgataacagctttgaaacaacttaaagtaccgaagctttacattcaattctttggagatggtcgtgatacgagtccaacaagcggagttggtttccttcaacagctaattgatttcgtcaacaaggaacaatatggtgaaatatcaacaatagtagggcgctactatgcgatggacagagataaacggtgggaacgaattcgggtatgttatgatgcactaattggtggagttggtgagaagactacaattgataaggcgattgatgttatcaaaggacgatatgcaaaggatgagactgatgaattcctaaaaccaataattctttcggatgaaggacgtacaaaagatggtgatactttgatattctttgattatcgtgctgatcgtatgcgagaaatcactgaatgcatgggtatggaacgatacaaagatcttaattctaatattaaacatccaaagaatatgcaagtaattggaatgactcagtacaaggcagaatttacctttcctgcactttttcctccggaatctcataaaaatgtattggcggaatggttatctgtaaatggattaacacaattccattgtgctgaaacagaaaaatatgcgcacgttacattcttcttcaatggtggtgtggaaaaacaatttgcaaatgaagagcgttgtttagtagtatctccgaaagttgccacttatgatcttgaaccaccaatgagttcagctgctgtagctgataaggtgattgagcaattgcatatgaaaaaacatccatttgttatgtgcaattttgcacctcccgatatggttggccatactggagtttatgaagcagccgtgaaagcagttgaagcaactgatattgctatcggacgaatatatgaagcatgtaagaagaatgactacatactgatggtaactgctgatcatggaaatgctgagaaaatgatggcaccagatggtagcaagcatactgctcacacttgcaatttagtgccattcacttgttcctcaatgaaatacaaattcatggacaagttaccggatcgggagatggctctttgtgatgttgctccaacagttctaaaagttatgggtgtgccattgccatccgagatgaccggacagccattggttaatgaagcctag

SEQ ID NO: 4 - DNA, 1548 bp, Onchocerca volvulus
atgagcgaagtgaaaaatcgggtatgtctggtagtgatcgatggttggggaatcagtaatgaaagcaaaggcaatgcaatactgaatgctaaaacaccggttatggatgagctttgtgcactcaattcacatccaatcgaagcacatggtttgcatgttggtttaccggaaggacttatgggtaattcggaagtgggtcatttgaatattggcgctggccgtgttgtttatcaggatattgtacgcataaatttggcggtcaaaaataaaacactggtagaaaataagcacttgaaagaagctgctgaacgtgccattaaaggaaatggccgcattcatttatgtggcttggttagcgatggtggtgttcattctcacatcgatcatttgtttgcgttgataacagctttaaaacagcttaaagtgccacagctttacatccacttcttcggagatggtcgtgatacgagtccaacaagtggagttggttttcttcaacagctgattgatttcgtcaataaggaacagtatggtgaaatagcgacaatagtagggcgctattacgcgatggacagagataagcgatgggagcgaattcgggtatgttatgatgcactgattgctggtgttggtgaaaagactacaattgataaagcaattgatgttatcaaaggacgatacgcaaaggatgaaactgatgaatttttaaaaccaataattctttcggataagggacgtacaaaagatggcgatactttgatattcttcgattatcgagctgatcgtatgcgagaaattactgagtgtatgggcatggaacgatataaggatctgaaatctgatattaaacatccgaaagatatgcaagtaattggaatgacgcaatataaggcagaatttacgtttcctgcacttttccctccagaatctcataaaaatgtattggcagaatggttatctgttaaaggattaacgcagttccattgtgctgagacagaaaaatatgcacatgtcacattctttttcaacggtggtgtagagaaacaatttgaaaatgaagaacgttgcttggtaccgtcaccgaaagttgcaacctacgatcttgaaccagccatgagttcagccggagtggctgataagatgatagaacagttgaatcgaaaagcacacgcatttattatgtgtaattttgcacctcctgatatggttggccatactggtgtttatgaagcggctgtgaaagcagttgaagcaacagatatcgcaattggacgaatatatgaagcatgtaagaagaacgattatgtacttatggtaactgccgatcatggcaatgctgaaaaaatgatagcgccagatggtggcaagcatactgctcatacttgcaatttagttccattcacttgttcgtcactgaaattcaagttcatggacaaattaccggatcgagaaatggctctttgcgatgttgctccaacagttttaaaagttttgggtttgccgttgccctccgagatgaccggaaagccagtggttattgaagtctag

SEQ ID NO: 5 - DNA, 1506 bp, unknown
  Wolbachia from Brugia
atgaactttaagtcagttgttttatgtatactagatggttgggggaatggaataggagatagtaaatacaatgccattagcaacgcaaatccaccctgttggcaatatattagctctaattatccaagatgcagtttatctgcctgtgggactgatgttggattaccagatggtcagataggcaactcagaggttggtcatatgaacatctgcagtggtagagtggtaatgcaaagcctgcagcgcattgatcgagaaatcaaaacaatagagaataacaagaatttacgaagttttattagtgatctaaaggataagaacggcgtgtgccacataatggggttggtatcagatggtggtgttcattcgcatcaaaaacatatttcaactttagcaaataaaatatcacagcacgaaatcaaagtagtgatacatgcatttttggacggcagagatacactgccaaattcaggaaaaaagtgcgttcaagaatttgaagagaatataaaaggcaatgacataagaattgctactgtctctgggcgttactatgctatggatcgcgataataggtgggaaagaacaatagaaacttacgaggctatcgcatttgcaagggcaacgtgtcacaataatgtgatgtcgttgattgataataactatcaaaataatataactgatgaatttattaggcctacagtaataggtgactacaaaggcatagaactaaaagatggggtgttattagccaactttcgtgctgatcgaatgatacaattggcaagtattttgctaggcaaaacaggttacactgaggtagcaaaattttcctcaattttaagtatgatgaagtataaggaagaccttcagattccttgtctttttccccctgcattttttaccaacactttaggagagataatagcagataataaattacggcaattacgcattgctgaaactgagaaatacgcccatgtgacttttttcttcaattgtggaaaggaagagcctttctccaatgaagaaagaatactcattccttcaccaaaagttgaaacttatgacctgcagcctgaaatgtcagcctttgaacttacagaaaaactcgtaggaaaaattcgttcccaagaatttacgctgatagttgcaaattacgctaaccctgacatggtgggacacacaggtaacatggaagcagccaaaaaagctgtgctggctgttgatgattgccttgcaaaagtattgaatactgttaaggaaataaacgacgctgtgttaattgttactgcagaccatggaaatgtggaatgtatgtttgatgaaaaaaataatacacctcacacagcacacactctaaataaagttccgtttattatataccctaattcttgtaacaacctaaagttgaaagatggaagattatctgatatcgctcctactattttacagttacttggaattaaaaaaccagatgaaatgacaggtagttcactgattgtgtaa

SEQ ID NO: 6 - protein, 19 aa, unknown
  consensus sequence for iPGM
MGNSEVGHLNIGAGRVVYQ

SEQ ID NO: 7 - protein, 539 aa, Caenorhabditis elegans
MFVALGAQIYRQYFGRRGMAMANNSSVANKVCLIVIDGWGVSEDPYGNAILNAQTPVMDKLCSGNWAQIEAHGLHVGLPEGLMGNSEVGHLNIGAGRVIYQDIVRINLAVKNNKFVTNESLVDACDRAKNGNGRLHLAGLVSDGGVHSHIDHMFALVKAIKELGVPELYLHFYGDGRDTSPNSGVGFLEQTLEFLEKTTGYGKLATVVGRYYAMDRDNRWERINVAYEAMIGGVGETSDEAGVVEVVRKRYAADETDEFLKPIILQGEKGRVQNDDTIIFFDYRADRMREISAAMGMDRYKDCNSKLAHPSNLQVYGMTQYKAEFPFKSLFPPASNKNVLAEWLAEQKVSQFHCAETEKYAHVTFFFNGGLEKQFEGEERCLVPSPKVATYDLQPEMSAAGVADKMIEQLEAGTHPFIMCNFAPPDMVGHTGVYEAAVKACEATDIAIGRIYEATQKHGYSLMVTADHGNAEKMKAPDGGKHTAHTCYRVPLTLSHPGFKFVDPADRHPALCDVAPTVLAIMGLPQPAEMTGVSIVQKI

SEQ ID NO: 8 - protein, 515 aa, Brugia malayi
MAEAKNRVCLVVIDGWGISNETKGNAILNAKTPVMDELCVMNSHPIQAHGLHVGLPEGLMGNSEVGHLNIGAGRVVYQDIVRINLAVKNKTLVENKHLKEAAERAIKGNGRMHLCGLVSDGGVHSHIDHLFALITALKQLKVPKLYIQFFGDGRDTSPTSGVGFLQQLIDFVNKEQYGEISTIVGRYYAMDRDKRWERIRVCYDALIGGVGEKTTIDKAIDVIKGRYAKDETDEFLKPIILSDEGRTKDGDTLIFFDYRADRMREITECMGMERYKDLNSNIKHPKNMQVIGMTQYKAEFTFPALFPPESHKNVLAEWLSVNGLTQFHCAETEKYAHVTFFFNGGVEKQFANEERCLVVSPKVATYDLEPPMSSAAVADKVIEQLHMKKHPFVMCNFAPPDMVGHTGVYEAAVKAVEATDIAIGRIYEACKKNDYILMVTADHGNAEKMMAPDGSKHTAHTCNLVPFTCSSMKYKFMDKLPDREMALCDVAPTVLKVMGVPLPSEMTGQPLVNEA

SEQ ID NO: 9 - protein, 500 aa, unknown
  Wolbachia from Brugia
MNFKSVVLCILDGWGNGIGDSKYNAISNANPPCWQYISSNYPRCSLSACGTDVGLPDGQIGNSEVGHMNICSGRVVMQSLQRIDREIKTIENNKNLRSFISDLKDKNGVCHIMGLVSDGGVHSHQKHISTLANKISQHEIKVVIHAFLDGRDTLPNSGKKCVQEFEENIKGNDIRIATVSGRYYAMDRDNRWERTIETYEAIAFARATCHNNVMSLIDNNYQNNITDEFIRPTVIGDYKGIELKDGVLLANFRADRMIQLASILLGKTGYTEVAKFSSILSMMKYKEDLQIPCLFPPAFFTNTLGEIIADNKLRQLRIAETEKYAHVTFFFNCGKEEPFSNEERILIPSPKVETYDLQPEMSAFELTEKLVGKIRSQEFTLIVANYANPDMVGHTGNMEAAKKAVLAVDDCLAKVLNTVKEINDAVLIVTADHGNVECMFDEKNNTPHTAHTLNKVPFIIYPNSCNNLKLKDGRLSDIAPTILQLLGIKKPDEMTGSSLI

SEQ ID NO: 10 - protein, 515 aa, Onchocerca volvulus
MSEVKNRVCLVVIDGWGISNESKGNAILNAKTPVMDELCALNSHPIEAHGLHVGLPEGLMGNSEVGHLNIGAGRVVYQDIVRINLAVKNKTLVENKHLKEAAERAIKGNGRIHLCGLVSDGGVHSHIDHLFALITALKQLKVPQLYIHFFGDGRDTSPTSGVGFLQQLIDFVNKEQYGEIATIVGRYYAMDRDKRWERIRVCYDALIAGVGEKTTIDKAIDVIKGRYAKDETDEFLKPIILSDKGRTKDGDTLIFFDYRADRMREITECMGMERYKDLKSDIKHPKDMQVIGMTQYKAEFTFPALFPPESHKNVLAEWLSVKGLTQFHCAETEKYAHVTFFFNGGVEKQFENEERCLVPSPKVATYDLEPAMSSAGVADKMIEQLNRKAHAFIMCNFAPPDMVGHTGVYEAAVKAVEATDIAIGRIYEACKKNDYVLMVTADHGNAEKMIAPDGGKHTAHTCNLVPFTCSSLKFKFMDKLPDREMALCDVAPTVLKVLGLPLPSEMTGKPVVIEV

SEQ ID NO: 11 - DNA, 32 bp, unknown
  primer
acgtggatccatgttcgtagccctgggcgctc

SEQ ID NO: 12 - DNA, 30 bp, unknown
  primer
acgtaagcttctagatcttctgaacaatcg

SEQ ID NO: 13 - DNA, 28 bp, unknown
  primer
agtcggatccatggcgatggcaaataac

SEQ ID NO: 14 - DNA, 27 bp, unknown
  primer
agtcaagcttgatcttctgaacaatcg

SEQ ID NO: 15 - DNA, 55 bp, unknown
  primer
atgcggatccatggccgaagcaaagaatcgagtatgtctggtagtgattgatggt

SEQ ID NO: 16 - DNA, 26 bp, unknown
  primer
actgctgcagctaggcttcattaacc

SEQ ID NO: 17 - DNA, 30 bp, unknown
  primer
agtcggatccatggccgaagcaaagaatcg

SEQ ID NO: 18 - DNA, 29 bp, unknown
  primer
atgcctcgagggcttcattaaccaatggc

SEQ ID NO: 19 - DNA, 23 bp, unknown
  primer
atgagcgaagtgaaaaatcgggt

SEQ ID NO: 20 - DNA, 21 bp, unknown
  primer
ctagacttcaataaccactgg

SEQ ID NO: 21 - DNA, 31 bp, unknown
  primer
atgaactttaagtcagttgttttatgtatac

SEQ ID NO: 22 - DNA, 32 bp, unknown
  primer
tacaagcttttacaatcagtgaactacctgtc

SEQ ID NO: 23 - DNA, 29 bp, unknown
  primer
agtcggatccatgaactttaagtcagttg

SEQ ID NO: 24 - DNA, 32 bp, unknown
  primer
atgcaagcttcacaatcagtgaactacctgtc

SEQ ID NO: 25 - protein, 491 aa, Brugia malayi
MAEAKNRVCLVVIDGWGISNETKGNAILNAKTPVMDELCVMNSHPIQAHGLHVGLPEGLMGNSEVGHLNIGAGRVVYQDIVRINLAVKNKTLVENKHLKEAAERAIKGNGRMHLCGLVSDGGVHSHIDHLFALITALKQLKVPKLYIQFFGDGRDTSPTSGVGFLQQLIDFVNKEQYGEISTIVGRYYAMDRDKRWERIRVCYDALIGGVGEKTTIDKAIDVIKGRYAKDETDEFLKPIILSDEGRTKDGDTLIFFDYRADRMREITECMGMERYKDLNSNIKHPKNMRSDESVTERTDEQIRKKKKQKNMRTLHSSSNGGVEKQFANEERCLVVSPKVATYDLEPPMSSAAVADKVIKQLHMKKHPFVMCNFAPPDMVGHTGVYEAAVKAVEATDIAIGRIYEACKKNDYILMVTADHGNAEKMMAPDGSKHTAHTCNLVPFTCSSMKYKFMDKLPDREMALCDVAPTVLKVMGVPLPSEMTGQPLVNEA

SEQ ID NO: 26 - protein, 520 aa, Aspergillus oryzae
MAKVDQKVVLVVIDGWGVAGPDSRKDGDAILAAETPFMSGFAEADSKTAQGYSELDASSLAVGLPEGLMGNSEVGHLNIGAGRVVWQDSVRIDQTLKKGELNKVDNVVASFKRAKEGNGRLHLLGLVSDGGVHSNITHLIGLLKVAKEMEIPKVFIHFFGDGRDTEPKSATKYMQQLLDQTKEIGIGEIATVVGRYWAMDRDKRWDRVEIAMKGIVSGEGEESSDPVKTINERYEKDETDEFLKPIIVGGEERRVKDDDTLFFFNYRSDRVREITQLLGDYDRSPKPDFPYPKNIHITTMTQYKTDYTFPVAFPPQHMGNVLAEWLSKKDVQQCHVAETEKYAHVTFFFNGGIEKQFAGEVRDMIPSPKVATYDLDPKMSAEAVGQKMADRIAEGKFEFVMNNFAPPDMVGHTGKYEAAIQGVAATDKAIGVIYEACKKQGYVLFITADHGNAEEMLTEKGTPKTSHTTNKVPFIMANAPEGWSLKKEGGVLGDVAPTVLAAMGIEQPEEMSGQNLLVKA

SEQ ID NO: 27 - protein, 503 aa, Encephalitozoon cuniculi
MMLLFKFVNRQGMGSVCLVVIDGWGHDETSTKGNAVNESRCRWMRELSRSRCSFLLFAHGRHVGLPDGLMGNSEVGHLTIGSGRIIEQDIVRIDRAVEEGRLKKMLDKELQGIDGKIHVVGMVSDGGVHSHIRHLKAILEALEGRNEEVFVHCVSDGRDTEPRVFLKYLKEVRDFLRVTEVGKVASIAGRFYSMDRANNDERTELSFRMMTRGREVGGDIRSHICAMYEEGLSDETLRPLLIDGRGRIDPKDTIIFFNFRADRMRQIASKFAKNGNSMITMTEYKKDLGSKVLFKKICVKNTLAEVLSSRGIRHSHIAENEKQAHVTYFFNGGREQAFSTQRTIILPSPGVQSFDAVPSMASREVAMSAVAEIEKGVPLVVVNLAPPDMVGHTGNFEATKAAVEVTDECIGKIYRACTRNRYTLVITADHGNAEKMVDKGGGCCKTHTTSKVPLIICEEGGVKASSSWGYVDSDHSLRDVAPTVLEIMGIPRPSEMTGKSVWR

SEQ ID NO: 28 - protein, 514 aa, Escherichia coli
MLVSKKPMVLVILDGYGYREEQQDNAIFSAKTPVMDALWANRPHTLIDASGLEVGLPDRQMGNSEVGHVNLGAGRIVYQDLTRLDVEIKDRAFFANPVLTGAVDKAKNAGKAVHIMGLLSAGGVHSHEDHIMAMVELAAERGAEKIYLHAFLDGRDTPPRSAESSLKKFEEKFAALGKGRVASIIGRYYAMDRDNRWDRVEKAYDLLTLAQGEFQADTAVAGLQAAYARDENDEFVKATVIRAEGQPDAAMEDGDALIFMNFRADRAREITRAFVNADFDGFARKKVVNVDFVMLTEYAADIKTAVAYPPASLVNTFGEWMAKNDKTQLRISETEKYAHVTFFFNGGVEESFKGEDRILINSPKVATYDLQPEMSSAELTEKLVAAIKSGKYDTIICNYPNGDMVGHTGVMEAAVKAVEALDHCVEEVAKAVESVGGQLLITADHGNAEQMRDPATGQAHTAHTNLPVPLIYVGDKNVKAVEGGKLSDIAPTMLSLMGMEIPQEMTGKPLFIVE

SEQ ID NO: 29 - protein, 510 aa, Vibrio cholerae
MSAKKPMALVILDGWGYREDNANNAINNARTPVMDSLMANNPHTLISASGMDVGLPDGQMGNSEVGHTNIGAGRIVYQDLTRITKAIMDGEFQHNKVLVAAIDKAVAAGKAVHLMGLMSPGGVHSHEDHIYAAVEMAAARGAEKIYLHCFLDGRDTPPRSAEASLKRFQDLFAKLGKGRIASIVGRYYAMDRDNNWDRVEKAYDLLTLAQGEFTYDSAVEALQAAYAREENDEFVKATEIRAAGQESAAMQDGDALLFMNYRADRARQITRTFVPDFAGFSRKAFPALDFVMLTQYAADIPLQCAFGPASLENTYGEWLSKAGKTQLRISETEKYAHVTFFFNGGVENEFPGEERQLVASPKVATYDLQPEMSSKELTDKLVAAIKSGKYDAIICNYPNGDMVGHTGVYEAAVKACEAVDECIGRVVEAIKEVDGQLLITADHGNAEMMIDPETGGVHTAHTSLPVPLIYVGNKAISLKEGGKLSDLAPTMLALSDLDIPADMSGQVLYS

SEQ ID NO: 30 - protein, 510 aa, Pseudomonas syringae
MTATPKPLVLIILDGFGHSESHKGNAILAAKMPVMDRLYQTMPNGLISGSGMDVGLPDGQMGNSEVGHMNLGAGRVVYQDFTRVTKAIRDGEFFENPTICAAVDKAVSAGKAVHIMGLLSDGGVHSHQDHLVAMAELAVKRGAEKIYLHAFLDGRDTPPRSAKKSLELMDATFARLGKGRTATIVGRYFAMDRDNRWDRVSSAYNLIVDSTADFHADSAVAGLEAAYARDENDEFVKATRIGEAARVEDGDAVVFMNFRADRARELTRVFVEDDFKDFERARQPKVNYVMLTQYAASIPAPSAFAAGSLKNVLGEYLADNGKTQLRIAETEKYAHVTFFFSGGREEPFPGEERILIPSPKVATYDLQPEMSAPEVTDKIVDAIEHQRYDVIVVNYANGDMVGHSGIMEAAIKAVECLDVCVGRIAEALEKVGGEALITADHGNVEQMTDDSTGQAHTAHTSEPVPFVYVGKRQLKVRQGGVLADVAPTMLHLLGMEKPQEMTGHSILVAE

SEQ ID NO: 31 - protein, 511 aa, Bacillus subtilis
MSKKPAALIILDGFGLRNETVGNAVALAKKPNFDRYWNQYPHQTLTASGEAVGLPEGQMGNSEVGHLNIGAGRIVYQSLTRVNVAIREGEFERNQTFLDAISNAKENNKALHLFGLLSDGGVHSHINHLFALLKLAKKEGLTKVYIHGFLDGRDVGPQTAKTYINQLNDQIKEIGVGEIASISGRYYSMDRDKRWDRVEKAYRAMAYGEGPSYRSALDVVDDSYANGIYDEFVIPSVITKENGEPVAKIQDGDSVIFYNFRPDRAIQISNTFTNKDFRDFDRGENYPKNLYFVCLTHFSETVDGYVAFKPINLDNTVGEVLSQHGLKQLRIAETEKYPHVTFFMSGGREAEFPGEERILINSPKVATYDLKPEMSAYEVKDALVKEIEADKHDAIILNFANPDMVGHSGMVEPTIKAIEAVDECLGEVVDAILAKGGHAIITADHGNADILITESGEPHTAHTTNPVPVIVTKEGITLREGGILGDLAPTLLDLLGVEKPKEMTGTSLIQK

SEQ ID NO: 32 - protein, 511 aa, Bacillus stearothermophilus
MSKKPVALIILDGFALRDETYGNAVAQANKPNFDRYWNEYPHTTLKACGEAVGLPEGQMGNSEVGHLNIGAGRIVYQSLTRINIAIREGEFDRNETFLAAMNHVKQHGTSLHLFGLLSDGGVHSHIHHLYALLRLAAKEGVKRVYIHGFLDGRDVGPQTAPQYIKELQEKIKEYGVGEIATLSGRYYSMDRDKRWDRVEKAYRAMVYGEGPTYRDPLECIEDSYKHGIYDEFVLPSVIVREDGRPVATIQDNDAIIFYNFRPDRAIQISNTFTNEDFREFDRGPKHPKHLFFVCLTHFSETVKGYVAFKPTNLDNTIGEVLSQHGLRQLRIAETEKYPHVTFFMSGGREEKFPGEDRILINSPKVPTYDLKPEMSAYEVTDALLKEIEADKYDAIILNYANPDMVGHSGKLEPTIKAVEAVDECLGKVVDAILAKGGIAIITADHGNADEVLTPDGKPQTAHTTNPVPVIVTKKGIKLRDGGILGDLAPTMLDLLGLPQPKEMTGKSLIVK

SEQ ID NO: 33 - protein, 509 aa, Bacillus anthracis
MRKPTALIILDGFGLREETYGNAVAQAKKPNFDGYWNKFPHTTLTACGEAVGLPEGQMGNSEVGHLNIGAGRIVYQSLTRVNVAIREGEFDKNETFQSAIKSVKEKGTALHLFGLLSDGGVHSHMNHMFALLRLAAKEGVEKVYIHAFLDGRDVGPKTAQSYIDATNEVIKETGVGQFATISGRYYSMDRDKRWDRVEKCYRAMVNGEGPTYKSAEECVEDSYANGIYDEFVLPSVIVNEDNTPVATINDDDAVIFYNFRPDRAIQIARVFTNGDFREFDRGEKVPHIPEFVCMTHFSETVDGYVAFKPMNLDNTLGEVVAQAGLKQLRIAETEKYPHVTFFFSGGREAEFPGEERILINSPKVATYDLKPEMSIYEVTDALVNEIENDKHDVIILNFANCDMVGHSGMMEPTIKAVEATDECLGKVVEAILAKDGVALITADHGNADEELTSEGEPMTAHTTNPVPFIVTKNDVELREDGILGDIAPTMLTLLGVEQPKEMTGKTIIK

SEQ ID NO: 34 - protein, 512 aa, Clostridium perfringens
MSKKPVMLMILDGFGISPNKEGNAVAAANKPNYDRLFNKYPHTELQASGLEVGLPEGQMGNSEVGHLNIGAGRIIYQELTRITKEIKEGTFFTNKALVKAMDEAKENNTSLHLMGLLSNGGVHSHIDHLKGLLELAKKKGLQKVYVHAFMDGRDVAPSSGKDFIVELENAMKEIGVGEIATISGRYYAMDRDNRWERVELAYNAMALGEGEKASSAVEAIEKSYHDNKTDEFVLPTVIEEDGHPVARIKDGDSVIFFNFRPDRAREITRAIVDPEFKGFERKQLHVNFVCMTQYDKTLECVDVAYRPESYTNTLGEYVASKGLNQLRIAETEKYAHVTFFFNGGVEQPNTNEDRALIASPKVATYDLKPEMSAYEVTDELINRLDQDKYDMIILNFANPDMVGHTGVQEAAVKAIEAVDECLGKVADKVLEKEGTLFITADHGNAEVMIDYSTGKPMTAHTSDPVPFLWVSKDAEGKSLKDGGKLADIAPTMLTVMGLEVPSEMTGTCLLNK

SEQ ID NO: 35 - protein, 521 aa, Methanosarcina mazeii
MRISLHMTQARRPLMLMILDGWGYREEKEGNAILAASTPHLDRLQKERPSCFLETSGEAVGLPQGQMGNSEVGHLNIGAGRVVYQDLTKINVSIRNGDFFENPVLLDAISNVKLNNSSLHLMGLVSYGGVHSHMTHLYALIKLAQEKGLKKVYIHVFLDGRDVPPKAALGDVKELDAFCKENQSVKIATVQGRYYAMDRDKRWERTKLAYDALTLGVAPYKTSDAVTAVSEAYERGETDEFIKPTIVTDSEGNPEAVIQDTDSIVFLNFRPDRARQLTWAFVKDDFEGFTREKRPKVHYVCMAQYDETLDLPIAFPPEELTDVLGKVLSDRGLIQLRIAETEKYAHVTFFLNGGQEKCYSGEDRCLIPSPKISTYDLKPEMSAYEVTDEVVKRILSGKYDVIILNFANMDMVGHTGDFEAAVKAVETVDNCVGRIVEALRTAGGAALITADHGNAEQMENSHTGEPHTAHTSNPVKCIYTGNGEVKALENGKLSDLAPTLLDLLEIPKPEKMTGRSLIVRK

SEQ ID NO: 36 - protein, 508 aa, Mycoplasma pneumoniae
MHKKVLLAILDGYGISNKQHGNAVYHAKTPALDSLIKDYPCVMLEASGEAVGLPQGQIGNSEVGHLNIGAGRIVYTGLSLINQNIKTGAFHHNQVLLEAIARAKANNAKLHLIGLFSHGGVHSHMDHLYALIKLAAPQVKMVLHLFGDGRDVAPCTMKSDLEAFMVFLKDYHNVIIGTLGGRYYGMDRDQRWDREEIAYNAILGNSKASFTDPVAYVQSAYDQKVTDEFLYPAVNGNVDKEQFALKDHDSVIFFNFRPDRARQMSHMLFQTDYYDYTPKAGRKYNLFFVTMMNYEGIKPSAVVFPPETIPNTFGEVIAHNKLKQLRIAETEKYAHVTFFFDGGVEVDLPNETKCMVPSLKVATYDLAPEMACKGITDQLLNQINQFDLTVLNFANPDMVGHTGNYAACVQGLEALDVQIQRIIDFCKANHITLFLTADHGNAEEMIDSNNNPVTKHTVNKVPFVCTDTNIDLQQDSASLANIAPTILAYLGLKQPAEMTANSLLISKK

SEQ ID NO: 37 - protein, 491 aa, Helicobacter pylori
MAQKTLLIITDGIGYRKDSDHNAFFHAKKPTYDLMFKTLPYSLIDTHGLSVGLPKGQMGNSEVGHMCIGAGRVLYQDLVRISLSLQNDELKNNPAFLNTIQKSHVVHLMGLMSDGGVHSHIEHFIALALECEKSHKKVCLHLITDGRDVAPKSALTYLKQMQNICNENIQIATISGRFYAMDRDNRFERIELAYNSLMGLNHTPLSPSEYIQSQYDKNITDEFIIPACFKNYCGMQDDESFIFINFRNDRAREIVSALGQKEFNSFKRQAFKKLHIATMTPYDNSFPYPVLFPKESVQNTLAEVVSQHNLTQSHIAETEKYAHVTFFINGGVETPFKNENRVLIQSPKVTTYDLKPEMSAKGVTLAVLEQMRLGTDLIIVNFANGDMVGHTGNFEASIKAVEAVDACLGEILSLAKELDYAMLLTSDHGNCERMKDENQNPLTNHTAGSVYCFVLGNGVKSIKNGALNNIASSVLKLMGIKAPATMDEPLF

SEQ ID NO: 38 - protein, 511 aa, Streptomyces coelicolor
MSTPEPVLAGPGILLVLDGWGSADAADDNALSLARTPVLDELVAQHPSTLAEASGEAVGLLPGTVGNSEIGHMVIGAGRPLPYDSLLVQQAIDSGALRSHPRLDAVLNEVAATSGALHLIGLCSDGQIHAHVEHLSELLAAAATHQVERVFIHAITDGRDVADHTGEAYLTRVAELAAAAGTGQIATVIGRGYAMDKAGDLDLTERAVALVADGRGSPADSAHSAVHSSERGDEWVPASVLTEAGDARVADGDAVLWFNFRSDRIQQFADRLHEHLTASGRTVNMVSLAQYDTRTAIPALVKRADASGGLADELQEAGLRSVRIAETEKFEHVTYYINGRDATVRDGEEHVRITGEGKADYVAHPHMNLDRVTDAVVEAAGRVDVDLVIANLANIDVVGHTGNLAATVTACEATDAAVDQILQAARNSGRWVVAVGDHGNAERMTKQAPDGSVRPYGGHTTNPVPLVIVPNRTDTPAPTLPGTATLADVAPTILHLLGHKPGPAMTGRPLL

SEQ ID NO: 39 - protein, 557 aa, Arabidopsis thaliana
MATSSAWKLDDHPKLPKGKTIAVIVLDGWGESAPDQYNCIHNAPTPAMDSLKHGAPDTWTLIKAHGTAVGLPSEDDMGNSEVGHNALGAGRIFAQGAKLCDQALASGKIFEGEGFKYVSESFETNTLHLVGLLSDGGVHSRLDQLQLLIKGSAERGAKRIRVHILTDGRDVLDGSSVGFVETLEADLVALRENGVDAQIASGGGRMYVTLDRYENDWEVVKRGWDAQVLGEAPHKFKNAVEAVKTLRKEPGANDQYLPPFVIVDESGKAVGPIVDGDAVVTFNFRADRMVMHAKALEYEDFDKFDRVRYPKIRYAGMLQYDGELKLPSRYLVSPPEIDRTSGEYLTHNGVSTFACSETVKFGHVTFFWNGNRSGYFNEKLEEYVEIPSDSGISFNVQPKMKALEIGEKARDAILSGKFDQVRVNIPNGDMVGHTGDIEATVVACEAADLAVKMIFDAIEQVKGIYVVTADHGNAEDMVKRDKSGKPALDKEGKLQILTSHTLKPVPIAIGGPGLAQGVRFRKDLETPGLANVAATVMNLHGFVAPSDYEPTLIEVVE

SEQ ID NO: 40 - protein, 550 aa, Trypanosoma brucei
MALTLAAHKTLPRRKLVLVVLDGVGIGPRDEYDAVHVAKTPLMDALFNDPKHFRSICAHGTAVGLPTDADMGNSEVGHNALGAGRVVLQGASLVDDALESGEIFTSEGYRYLHGAFSQPGRTLHLIGLLSDGGVHSRDNQVYQILKHAGANGAKRIRVHALYDGRDVPDKTSFKFTDELEEVLAKLREGGCDARIASGGGRMFVTMDRYEADWSIVERGWRAQVLGEGRAFKSAREALTKFREEDANISDQYYPPFVIAGDDGRPIGTIEDGDAVLCFNFRGDRVIEMSRAFEEEEFDKFNRVRLPKVRYAGMMRYDGDLGIPNNFLVPPPKLTRTSEEYLIGSGCNIFALSETQKFGHVTYFWNGNRSGKLSEERETFCEIPSDRVQFNQKPLMKSKEITDAAVDAIKSGKYDMIRINYPNGDMVGHTGDLKATITSLEAVDQSLQRLKEAVDSVNGVFLITADHGNSDDMVQRDKKGKPVRDAEGNLMPLTSHTLAPVLFLSEALVLIPVCKCGQTFRVRPCNVTATFINLMGFEAPSDYEPSLIEVA

SEQ ID NO: 41 - protein, 411 aa, Pyrococcus furiosus
MKQRKGVLIILDGLGDRPIKELGGKTPLEYANTPTMDYLAKIGILGQQDPIKPGQPAGSDTAHLSIFGYDPYKSYRGRGYFEALGVGLELDEDDLAFRVNFATLENGVITDRRAGRISTEEAHELAKAIQENVDIPVDFIFKGATGHRAVLVLKGMAEGYKVGENDPHEAGKPPHPFTWEDEASKKVAEILEEFVKKAHEVLDKHPINEKRRKEGKPVANYLLIRGAGTYPNIPMKFTEQWKVKAAAVVAVALVKGVAKAIGFDVYTPKGATGEYNTDEMAKARKAVELLKDYDFVFIHFKPTDAAGHDNNPKLKAELIERADRMIKYIVDHVDLEDVVIAITGDHSTPCEVMNHSGDPVPLLIAGGGVRADYTEKFGEREAMRGGLGRIRGHDIVPIMMDLMNRTEKFGA

SEQ ID NO: 42 - protein, 519 aa, Neurospora crassa
MAPEHKACLIVIDGWGIPSEESPKNGDAIAAAETPVMDELSKSATGFSELEASSLAVGLPEGLMGNSEVGHLNIGAGRVVWQDVVRIDQTIKKGELSQNEVIKATFERAKNGNGRLHLCGLVSHGGVHSKQTHLYALLKAAKEAGVPKVFIHFFGDGRDTDPKSGAGYMQELLDTIKEIGIGELATVVGRYYAMDRDKRWERVEVALKGMILGEGEESTDPVKTIKERYEKGENDEFLKPIVVGGDERRIKEDDTVFFFNYRSDRVRQITQLMGGVDRSPLPDFPFPNIKLVTMTQYKLDYPFDVAFKPQQMDNVLAEWLGKQGVKQVHIAETEKYAHVTFFFNGGVEKVFPLETRDESQDLVPSNKSVATYDKAPEMSADGVANQVVKRLGEQEFPFVMNNFAPPDMVGHTGVYEAAIVGCAATDKAIGKILEGCKKEGYILFITSDHGNAEEMKFPDGKPKTSHTTNKVPFIMANAPEGWSLKKEGGVLGDVAPTILAAMGLPQPAEMTGQNLLVKA

SEQ ID NO: 43 - protein, 553 aa, Leishmania mexicana
MSALLLKPHKDLPRRTVLIVVMDGLGIGPEDDYDAVHMASTPFMDAHRRDNRHFRCVRAHGTAVGLPTDADMGNSEVGHNALGAGRVALQGASLVDDAIKSGEIYTGEGYRYLHGAFSKEGSTLHLIGLLSDGGVHSRDNQIYSIIEHAVKDGAKRIRVHALYDGRDVPDGSSFRFTDELEAVLAKVRQNGCDAAIASGGGRMFVTMDRYDADWSIVERGWRAQVLGDARHFHSAKEAITTFREEDPKVTDQYYPPFIVVDEQDKPLGTIEDGDAVLCVNFRGDRVIEMTRAFEDEDFNKFDRVRVPKVRYAGMMRYDGDLGIPNNFLVPPPKLTRVSEEYLCGSGLNIFACSETQKFGHVTYFWNGNRSGKIDEKHETFKEVPSDRVQFNEKPRMQSAAITEAAIEALKSGMYNVVRINFPNGDMVGHTGDLKATITGVEAVDESLAKLKDAVDSVNGVYIVTADHGNSDDMAQRDKKGKPMKDGNGNVLPLTSHTLSPVPVFIGGAGLDPRVAMRTDLPAAGLANVTATFINLLGFEAPEDYEPSLIYVEK

SEQ ID NO: 44 - protein, 589 aa, unknown
  Giardia lamblia
MSPGRKQLASHPFIKKGRRPVVLCIVDGMGYGRVKEADAVKAAYTPFLDMFHAKYPNTQLYAHGTYVGLPDDTDMGNSEVGHNCIGCGRVVAQGAKLVNMSLESGEMFREGSVWRKCVTQVTAKNSTLHFLGLFSDGNVHSHINHLFSMLKRAKQDGIKQVRLHLLFDGRDVGETSGMSYIEKLDELLKTLNGADFNCVVASGGGRMVTTMDRYFANWDIVERGYLAHIYGYSVHGNYYDSIANAYTALRNKGAIDQNLEEFVINDADGKPVGAVGDNDAFVLYNFRGDRAIEISQAMDALAGGDTAAFKDFNLCFDLSGIQRKYGAPNVKISLPSKIAAPKNILYVGMMLYDGDLHLPKNYLVSPPNISDTLDDYLTSAGLSCYAISETQKYGHVTYFFNGNRSEKFSEELDTYEEIPSDKDIEFSKAPWMRAHEITVMTERAIRGLTKRKHDFIRLNYPNPDMVGHCGDFEMARVAVECVDVCLGRLYKAVCDVGGCMVIIADHGNSDEMYEIVKGAVKLDSKGNKVVKTSHSLNPVPCIIIDKSSDVLEYKRELRSGKGLSSVAATILNLLGFEKPADYDDGVLVF

SEQ ID NO: 45 - protein, 559 aa, Zea mays
MGSSGFSWTLPDHPKLPKGKSVAVVVLDGWGEANPDQYNCIHVAQTPVMDSLKNGAPEKWRLVKAHGTAVGLPSDDDMGNSEVGHNALGAGRIFAQGAKLVDQALASGKIYDGDGFNYIKESFESGTLHLIGLLSDGGVHSRLDQLQLLLKGVSERGAKKIRVHILTDGRDVLDGSSIGFVETLENDLLELRAKGVDAQIASGGGRMYVTMDRYENDWDVVKRGWDAQVLGEAPYKFKSALEAVKTLRAQPKANDQYLPPFVIVDDSGNAVGPVLDGDAVVTINFRADRMVMLAKALEYADFDNFDRVRVPKIRYAGMLQYDGELKLPSRYLVSPPEIDRTSGEYLVKNGIRTFACSETVKFGHVTFFWNGNRSGYFDATKEEYVEVPSDSGITFNVAPNMKALEIAEKARDALLSGKFDQVRVNLPNGDMVGHTGDIEATVVACKAADEAVKIILDAVEQVGGIYLVTADHGNAEDMVKRNKSGKPLLDKNDRIQILTSHTLQPVPVAIGGPGLHPGVKFRNDIQTPGLANVAATVMNLHGFEAPADYEQTLIEVADN

SEQ ID NO: 46 - DNA, 1353 bp, unknown
  Wolbachia (Dirofilaria immitis) iPGM partial sequence
aactttaagtcagttgttttatgtatactagacggctgggggaatggaatagaaaatagtaagcacaatgctattagcaatgctaatccactctgttggcaatatattagctccaattatccaaaatgcagtttatctgcctgtggagttgacgttgggttaccaagtggtcaaatgggtaactcagaagttggtcatatgaatattggtggtggcagagtggaagtacaaagcctgcagcgtattaatcaaggaattggaacaatagaaagcaatgtgaatctacaaaattttattaatagcttaaaagataagaacggcgtgtgtcatataatgggactggtgtcagatggaggtgtccattcacatcaaaaacacattacaattttagcaaataaaatatcgcaacatggaatcaaagtggtggtacatgcatttctggatggtagggatacgttgccaaattcaggaaaaaaatgcattcaagagtttaaagaaagtgtaaggggcggtgacatagaaattgctactgtctctgggcgttattatgctatggaccgtgataataggtgggagagaacagttgaagcttatgaggctattgcatttacaaaagcaccgcgtcataataatgtaatgtctttgattgataatagctatcaaagcagcatagctgatgaatttgttagacctgcagtaataggtgagtatcaaggcataaagccagaagatggggtgttactggctaactttcgtgctgatcgtatgatacagttggcaagtattttacttggtaagacggactataataaagtagtaaagttttcttctattttaagtatgatgaaatataaagaaagtcttcagattccttgtctttttcctgctacatcttttgctgacactttaggacaagtgatagaagacaataagttacggcaattacgtattgctgaaactgagaaatacgcccatgtaactttcttctttaattgtaggaaagaaaagcctttttttggtgaagaaagaattttgattccttcaccaaaagttaaaacttatgatttgcaaccagaaatggcagcttttgagcttacagaaaaacttgtagagaaaattcattcccaagaatttgcactaatagttgtaaattatgctaaccctgatatgatagggcatacaggtaacatgaaagcagcagagaaggctgtgctggctgtagataattgccttgcaagagtgcttaatgctattaagaaagtaggtggtaatactgtacttattattacgtcagatcacggtaatattgagtgtgtattcgatgaagaaaataatacacctcatacagcacaa

SEQ ID NO: 47 - protein, 451 aa, unknown
  Wolbachia (Dirofilaria immitis) iPGM partial sequence
NFKSVVLCILDGWGNGIENSKHNAISNANPLCWQYISSNYPKCSLSACGVDVGLPSGQMGNSEVGHMNIGGGRVEVQSLQRINQGIGTIESNVNLQNFINSLKDKNGVCHIMGLVSDGGVHSHQKHITILANKISQHGIKVVVHAFLDGRDTLPNSGKKCIQEFKESVRGGDIEIATVSGRYYAMDRDNRWERTVEAYEAIAFTKAPRHNNVMSLIDNSYQSSIADEFVRPAVIGEYQGIKPEDGVLLANFRADRMIQLASILLGKTDYNKVVKFSSILSMMKYKESLQIPCLFPATSFADTLGQVIEDNKLRQLRIAETEKYAHVTFFFNCRKEKPFFGEERILIPSPKVKTYDLQPEMAAFELTEKLVEKIHSQEFALIVVNYANPDMIGHTGNMKAAEKAVLAVDNCLARVLNAIKKVGGNTVLIITSDHGNIECVFDEENNTPHTAQ

SEQ ID NO: 48 - DNA, 342 bp, unknown
  Dirofiliaria immitis iPGM partial sequence
ttggccatactggtgtttatgaagcagctgtgaaagcagttgaagcaactgatatcgcaattggacggatatatgaagcatgcaagaaaaacgattatatattgatggtaactgccgatcatggcaatgctgaaaaaatgatggcaccagatggtagcaaacatactgctcacacttgcaatttagttccattcacttgctcgtcaatgaaattcaaatttatggacaaattaccggatcgagagatggctctttgcgatgttgctccaacagttttaaaagttatgggtctgccgttgcctcctgagatgaccggacagccagtggttattgaagtctaga

SEQ ID NO: 49 - protein, 112 aa, unknown
  Dirofiliaria immitis iPGM partial sequence
GHTGVYEAAVKAVEATDIAIGRIYEACKKNDYILMVTADHGNAEKMMAPDGSKHTAHTCNLVPFTCSSMKFKFMDKLPDREMALCDVAPTVLKVMGLPLPPEMTGQPVVIEV